(19) United States
(12) Patent Application Publication
(10) Pub. No.: US 2006/0155638 A1
(43) Pub. Date: Jul. 13, 2006

(54) System & method for the creation of a global secure computerized electronic market-making exchange for currency yields arbitrage

(76) Inventor: Alain L. de la Motte, Hillsboro, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/298,314

(22) Filed: Dec. 8, 2005

Related U.S. Application Data
(60) Provisional application No. 60/634,897, filed on Dec. 8, 2004.

(51) Int. Cl. G06Q 40/00

(52) U.S. Cl. 705/37

(57) ABSTRACT

A multi-participant financial transaction with no downside risks that results in a net profit for all participants when the transaction is accomplished according to certain required steps, including the step of having simultaneously closings in escrow. A multi-step approach to issuing and selling custom-designed, specially engineered and underwritten securities or bank instruments is also described.

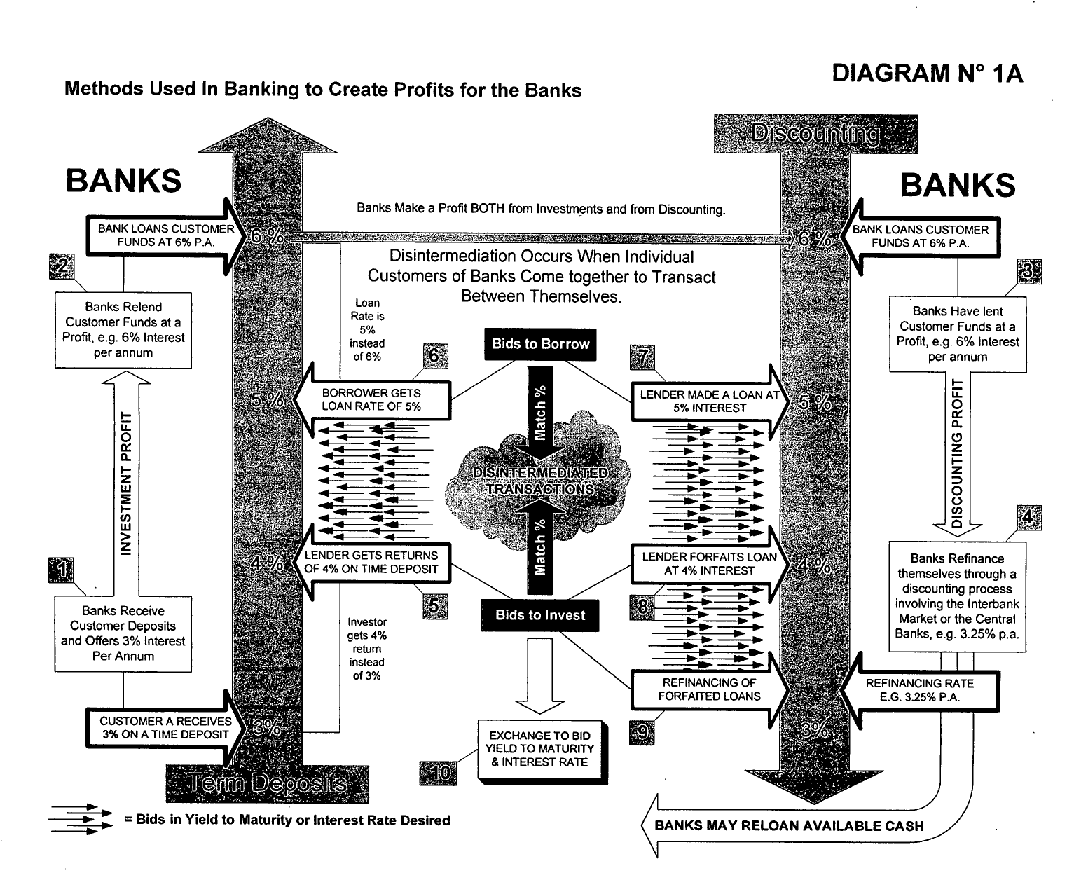

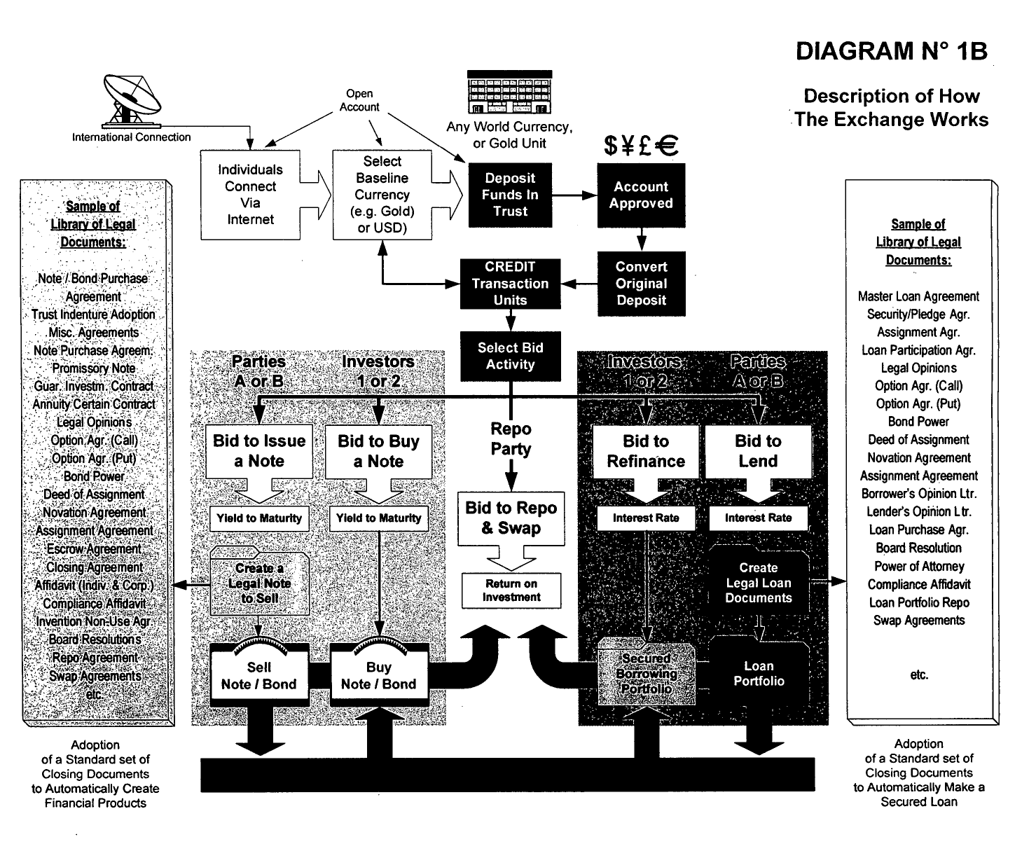

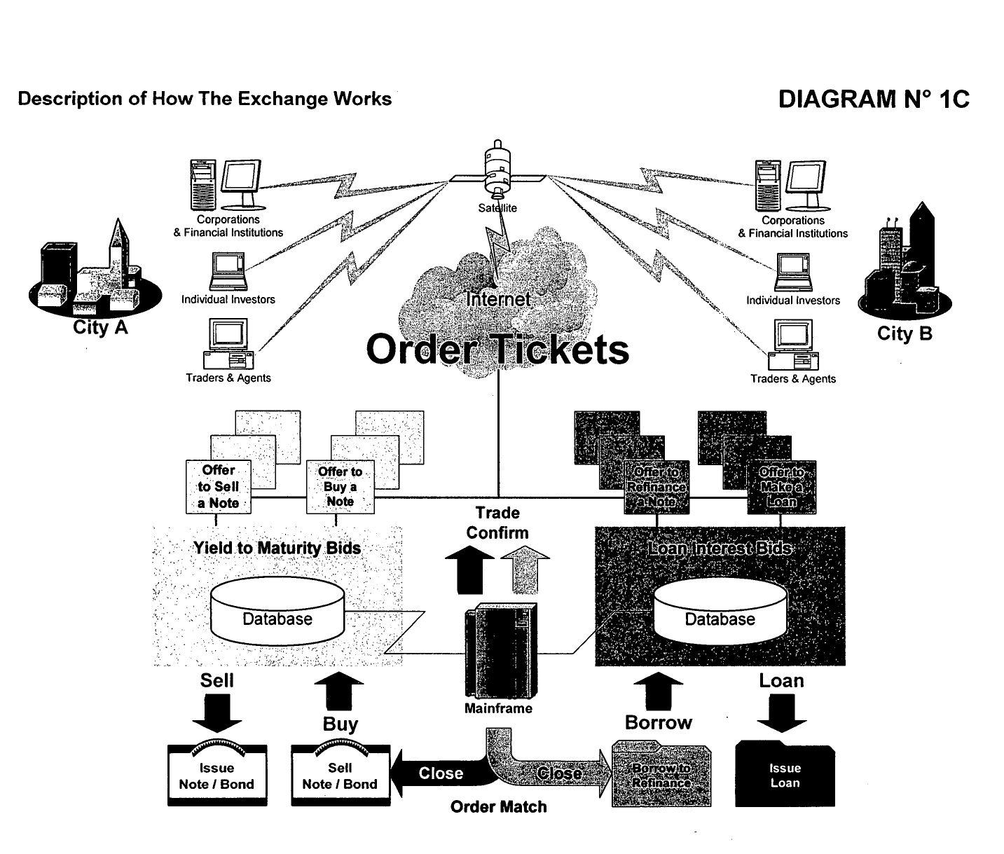

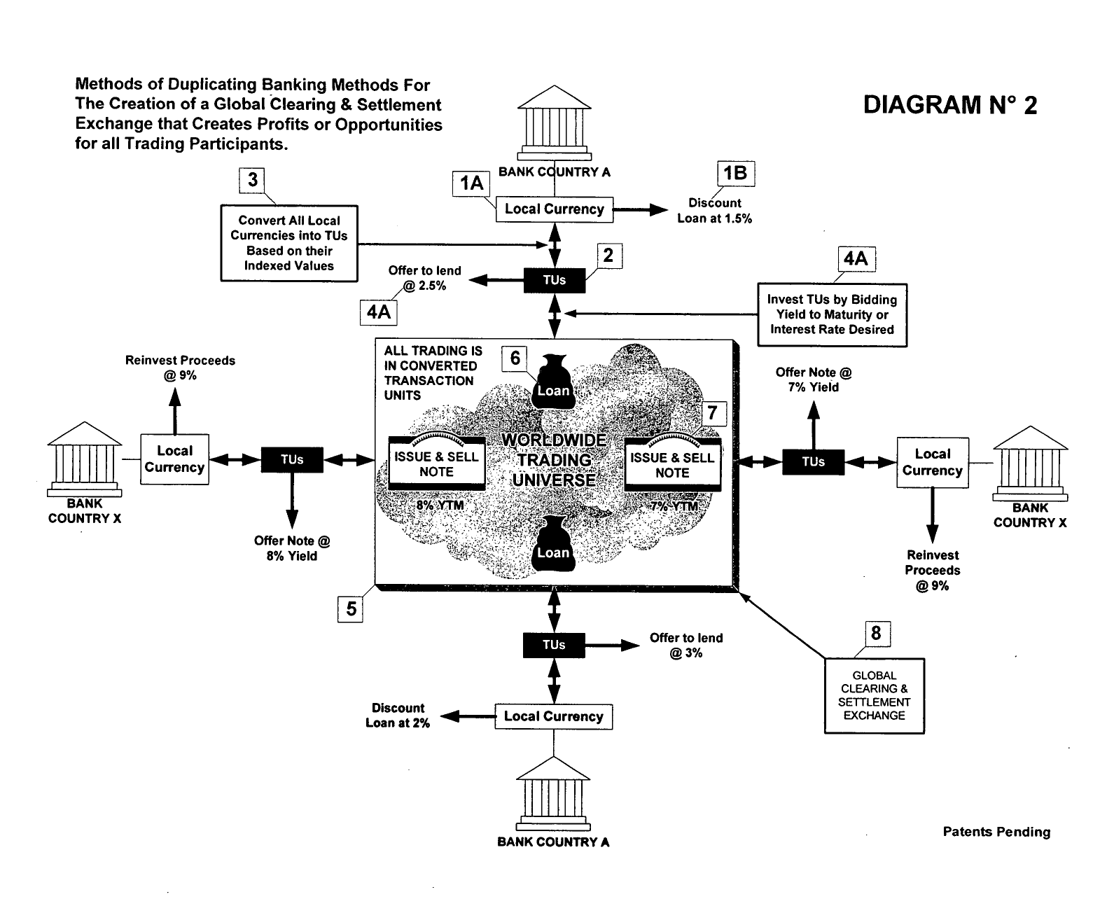

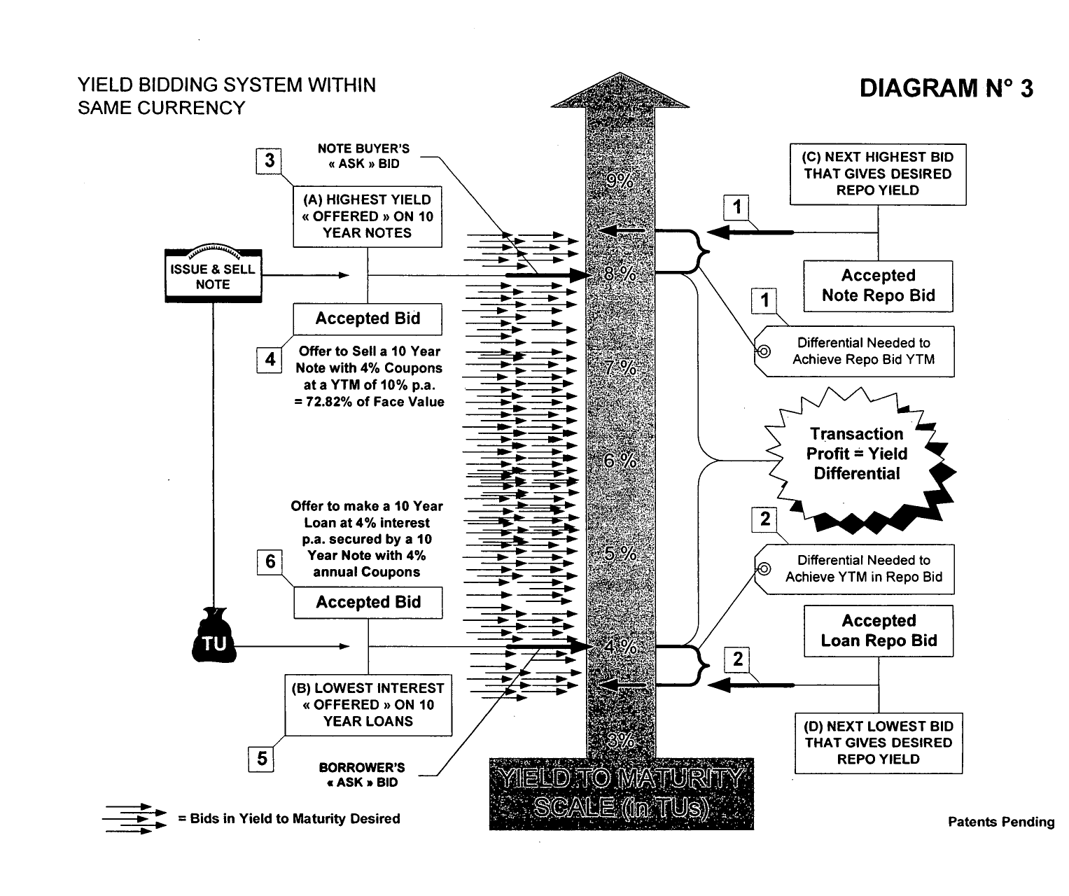

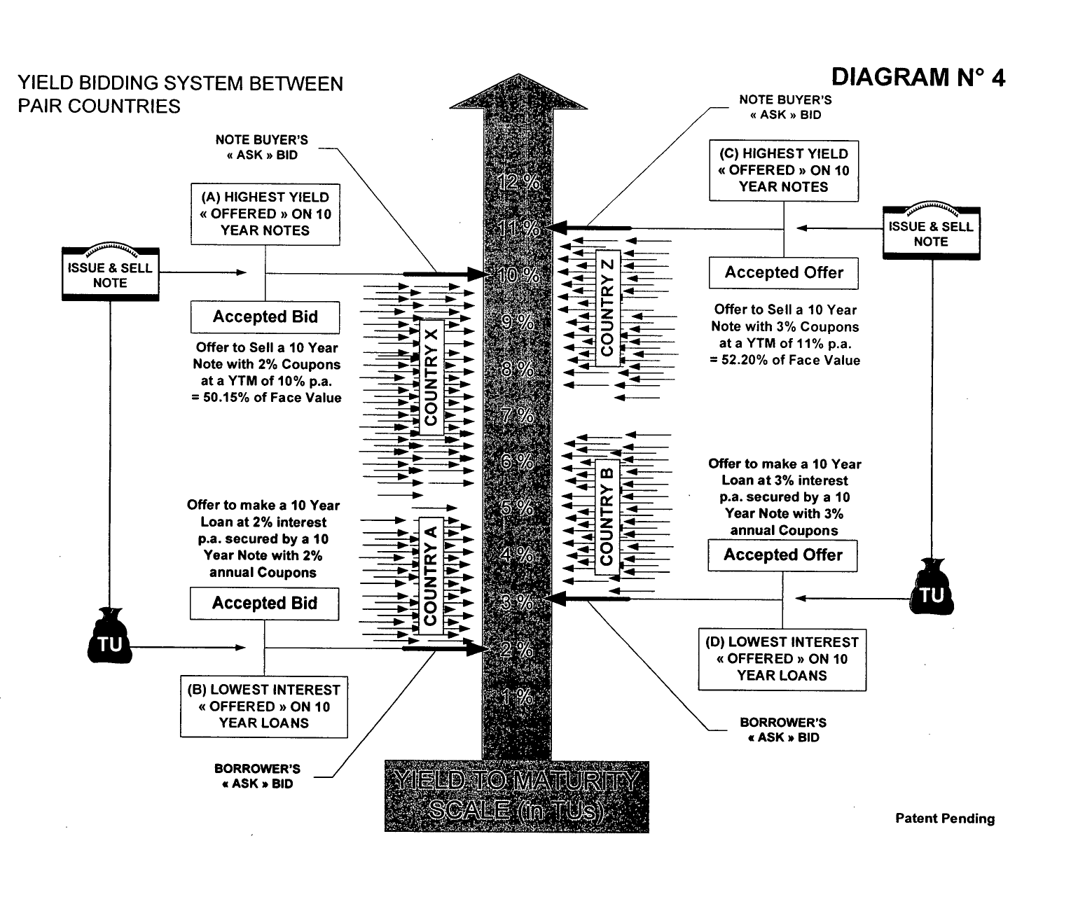

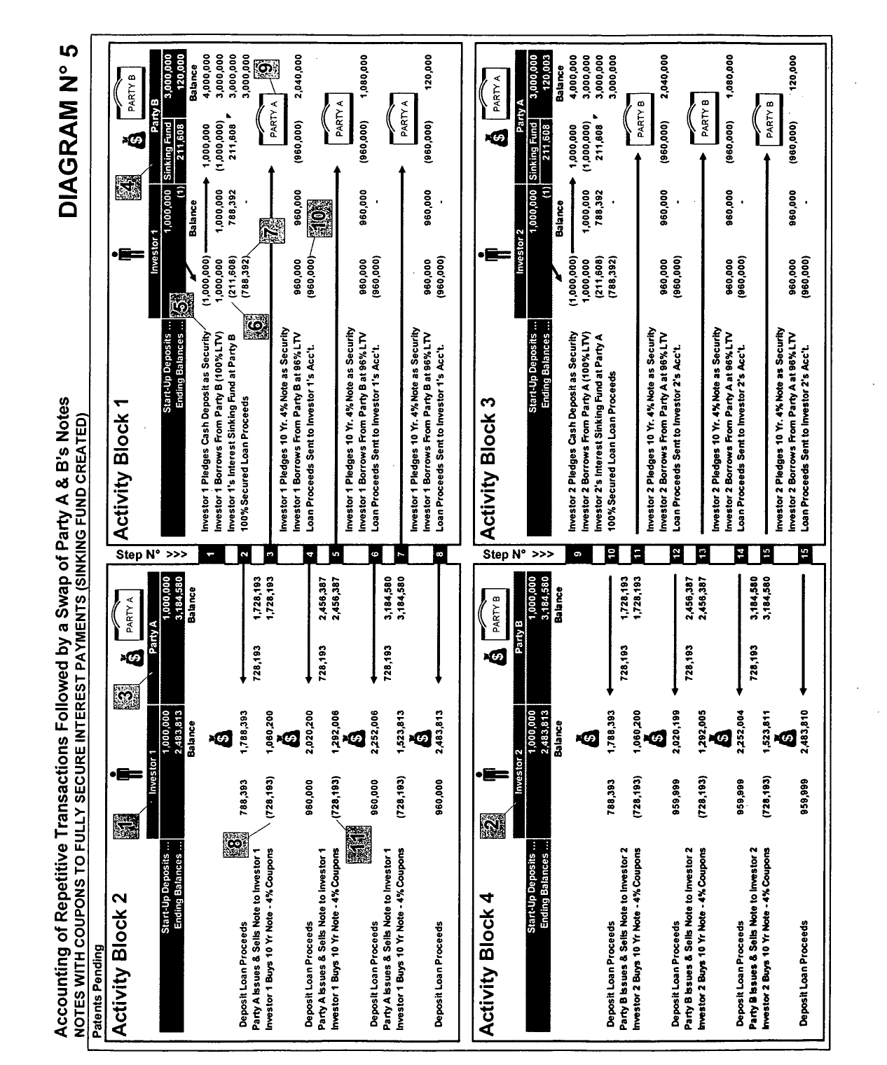

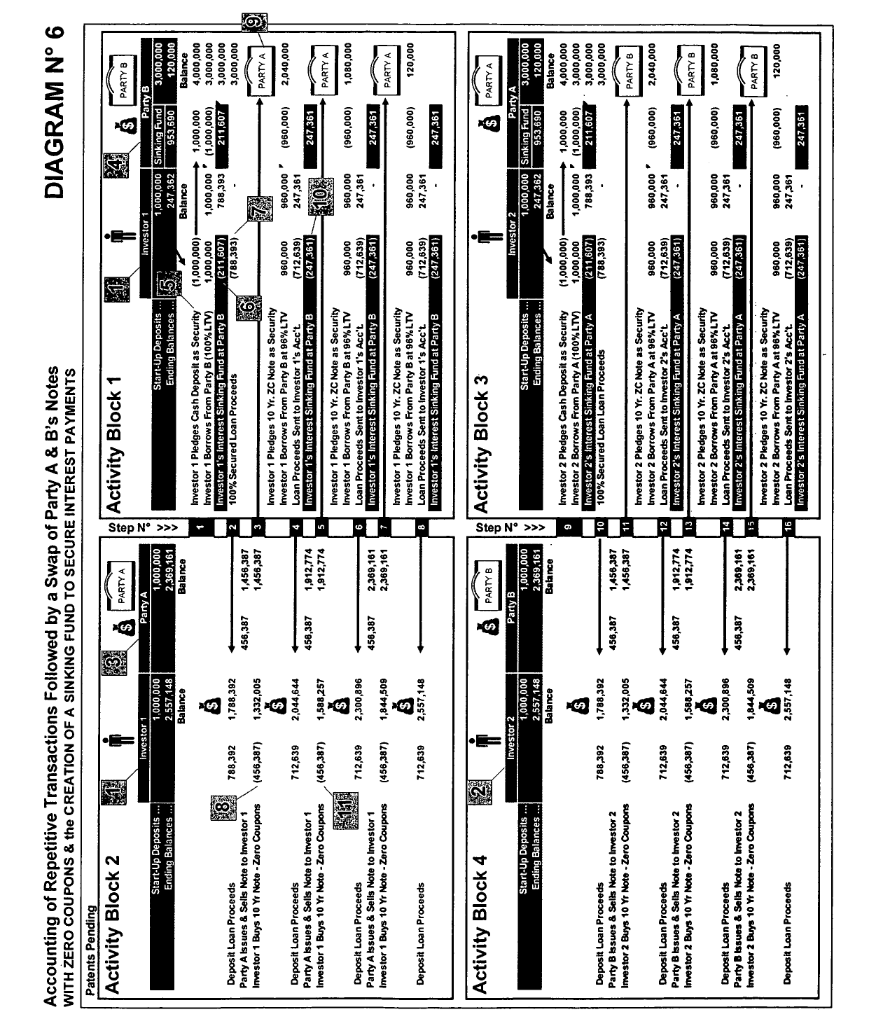

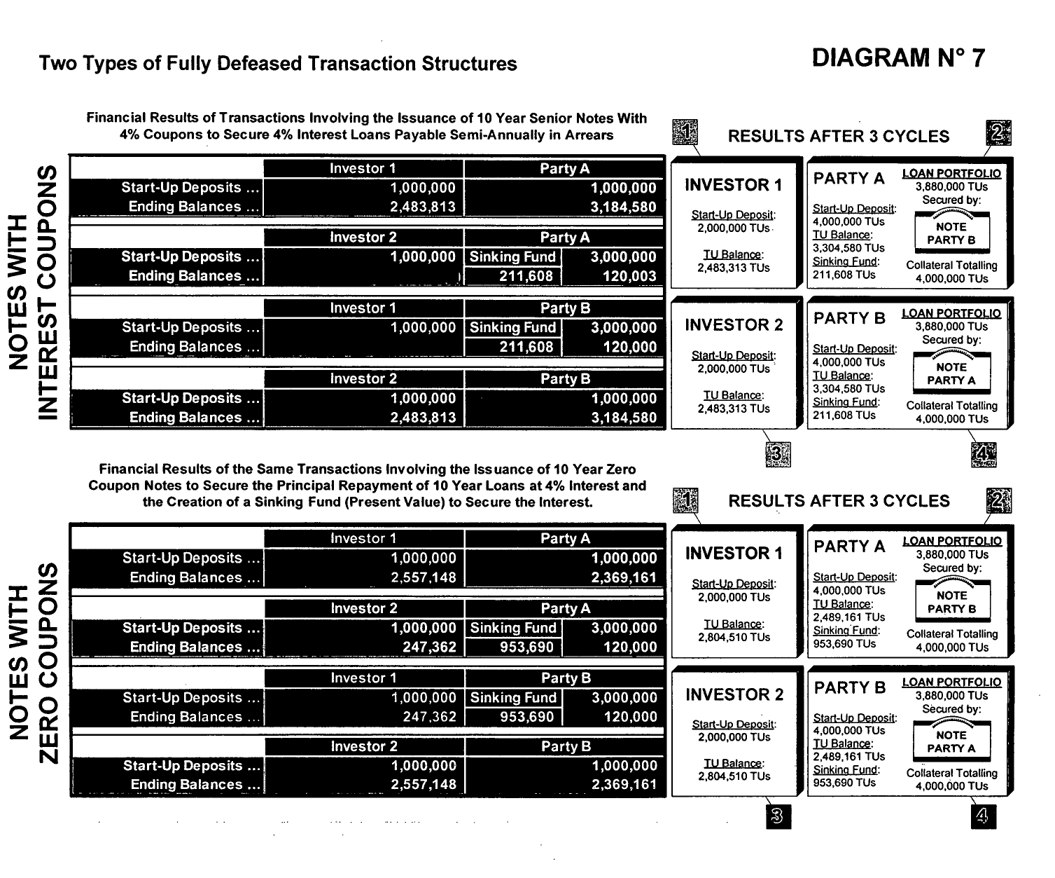

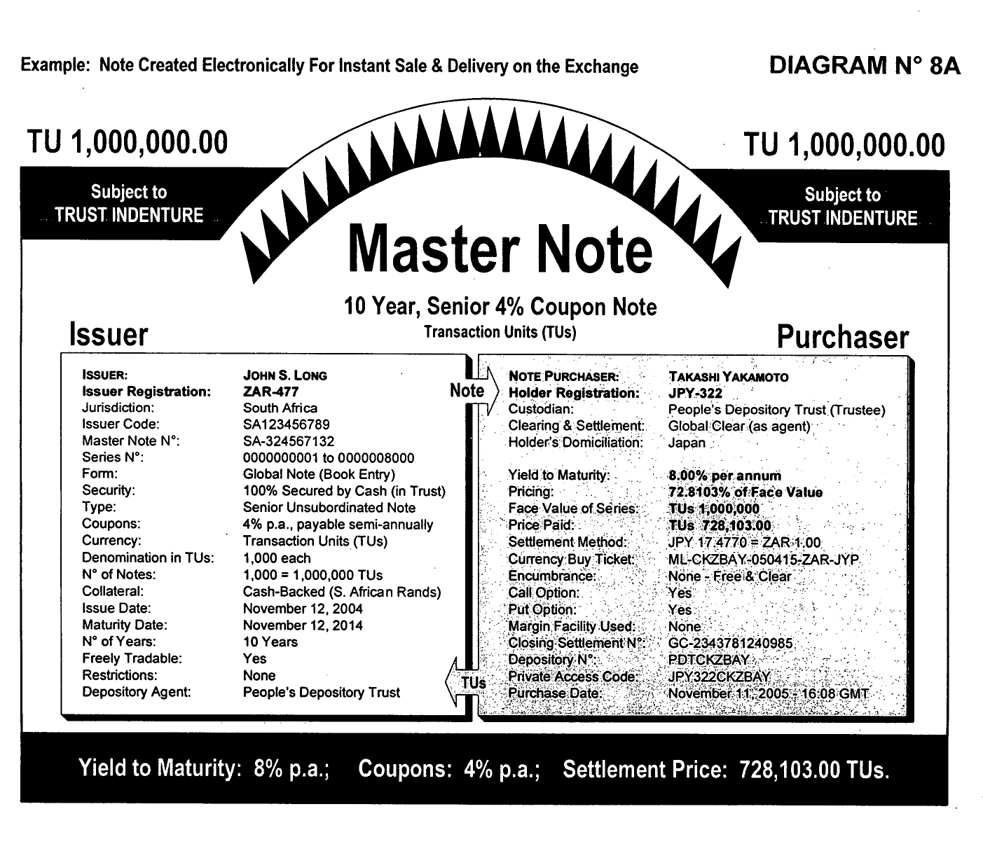

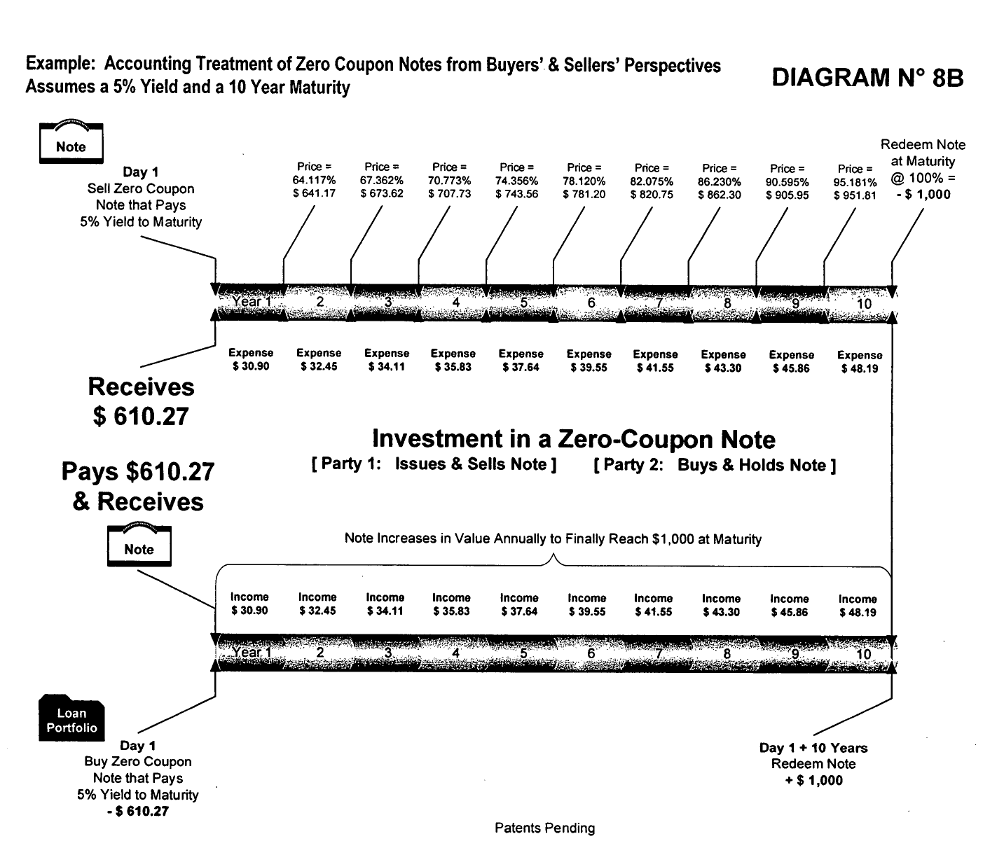

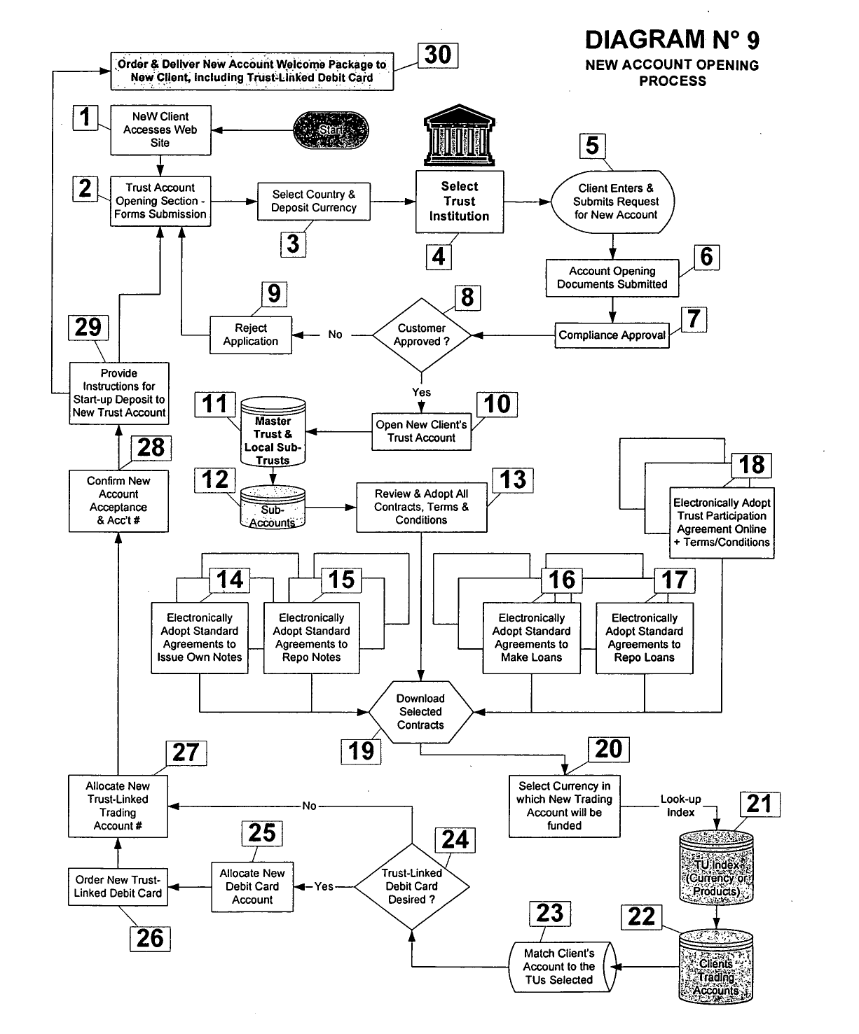

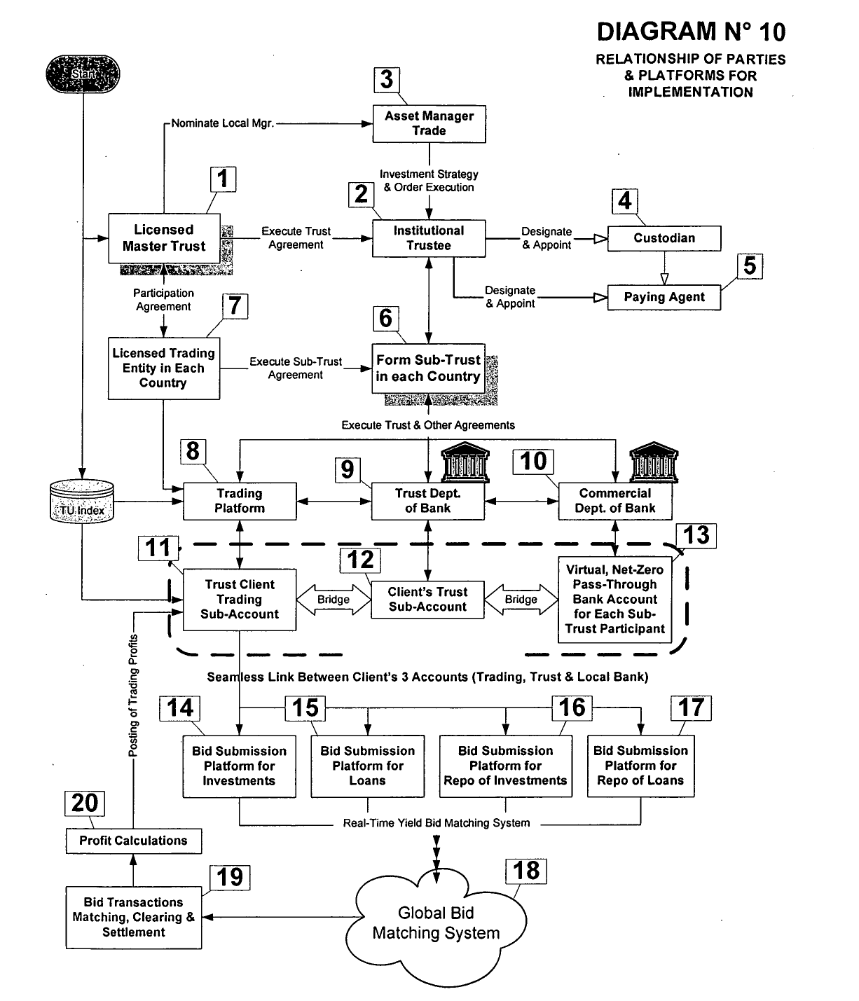

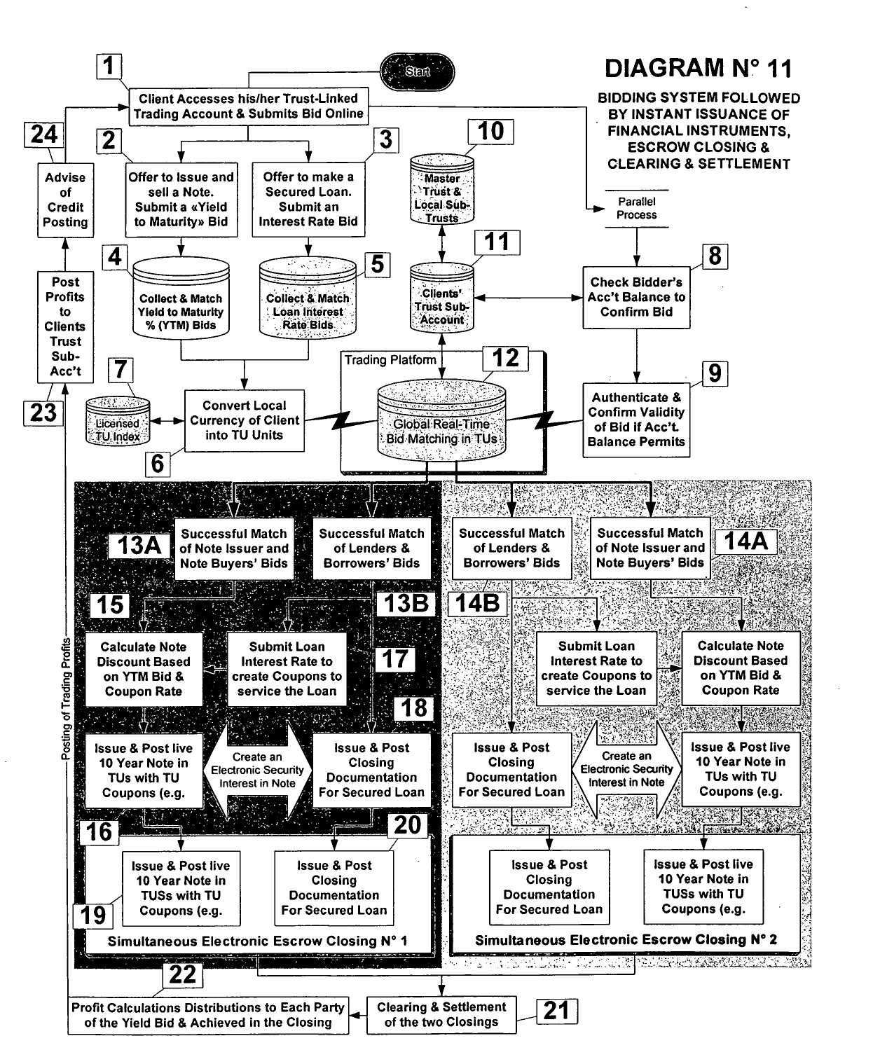

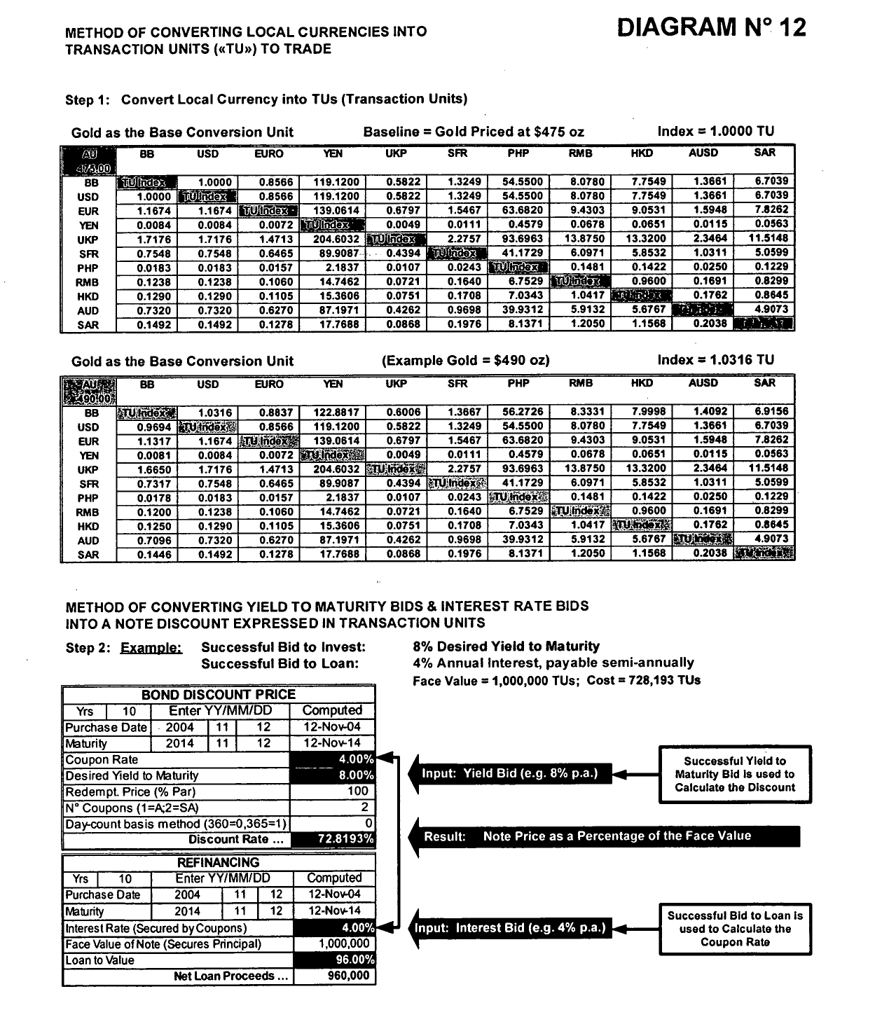

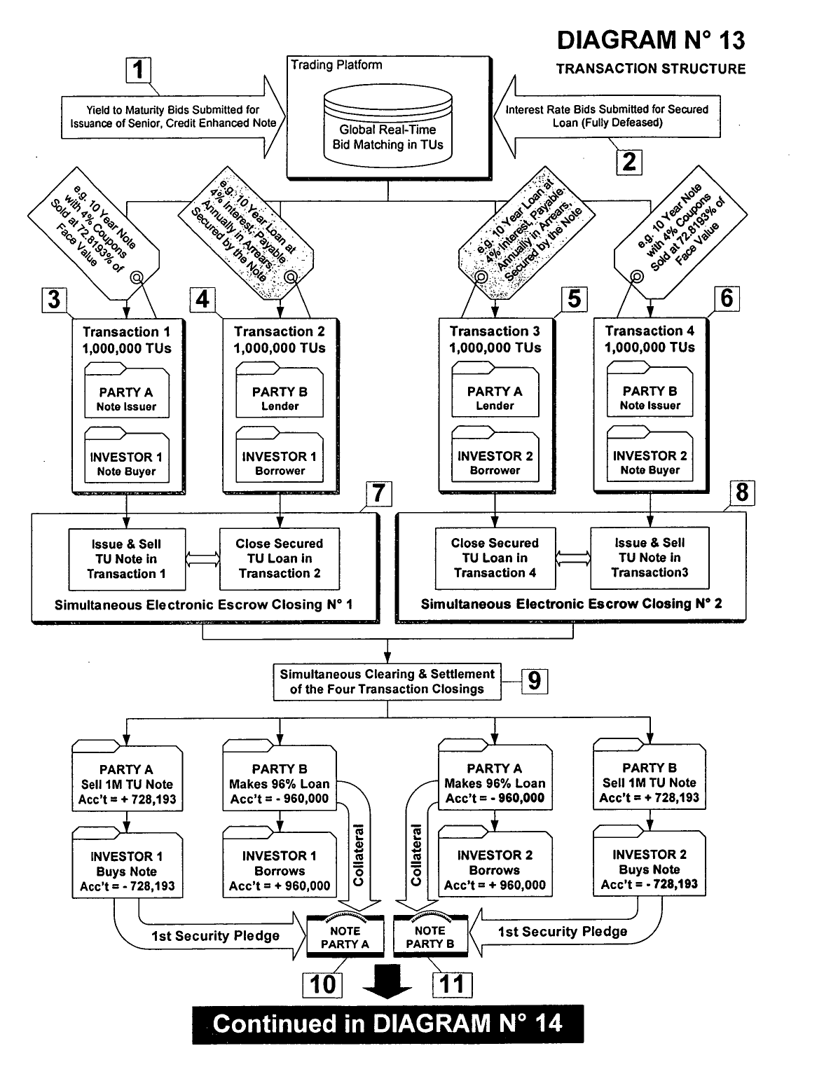

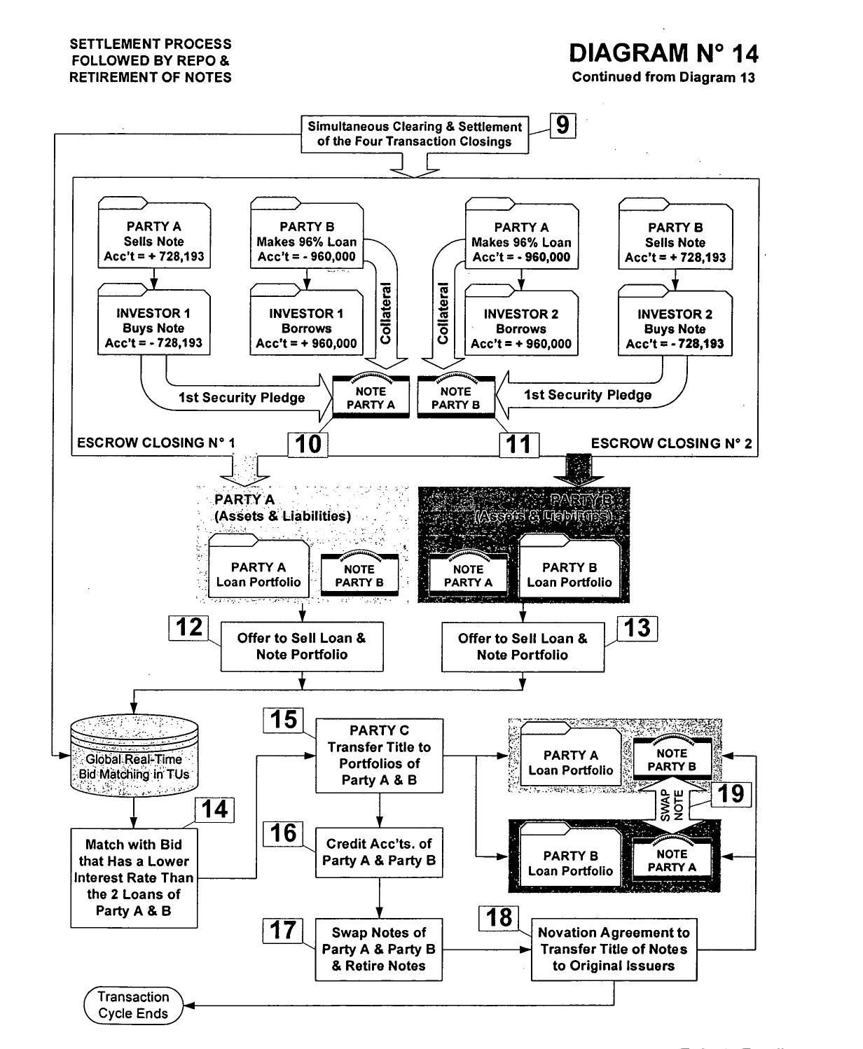

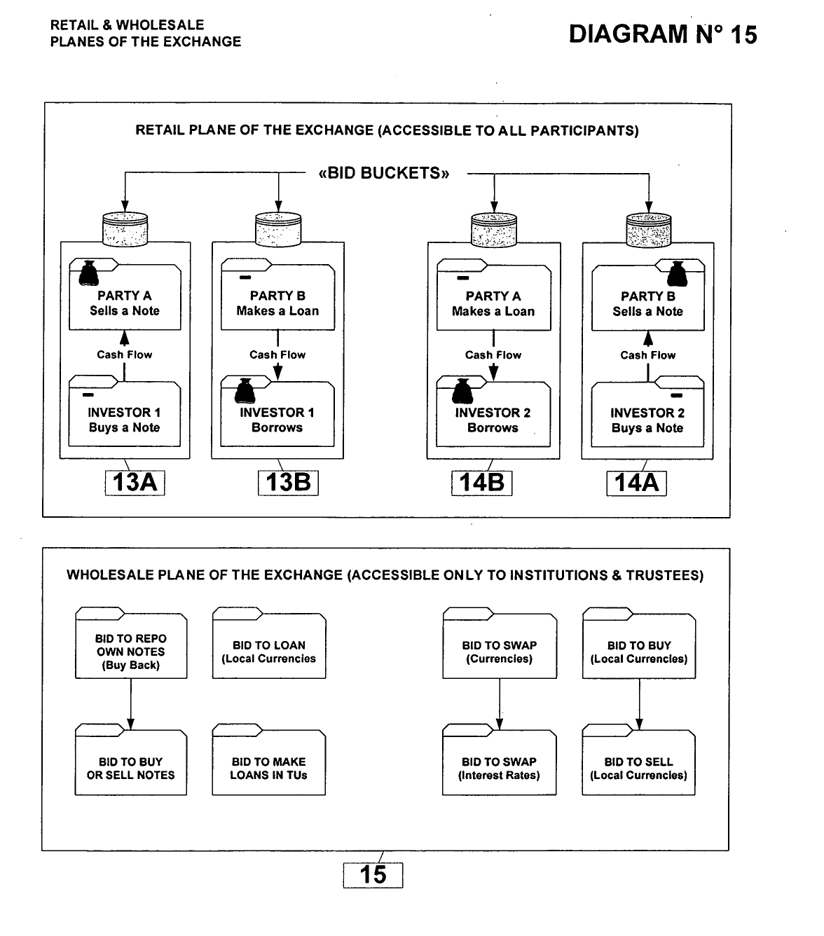

### CROSS-REFERENCE TO RELATES APPLICATIONS

This application claims priority to the following U.S. Provisional Patent Applications: (i) Serial No. 60/634,897, filed on Dec. 8, 2004 and entitled “System & Method to Allow Investors and Financial Institutions to Profit Through the Creation of Synthetic Interest Rate Arbitrage Transaction Opportunities that Minimize or Eliminate all Risks for Investors and Financial Institutions Alike”, which is incorporated herein by reference.

### TECHNICAL FIELD

The Invention relates to electronic exchanges that facilitate online interaction of individuals, institutions, or corporate entities to close and settle desired transactions.

### BACKGROUND

Every United States Dollar bill bears on its face, the statement: “Federal Reserve Note”. Each bill represents an unsecured promissory note, or an unconditional promise of the Federal Reserve Board to pay the bearer its face value on demand. It is what is commonly referred to as “fiat” money because it is only backed by the “faith and trust” placed in the government that causes the note to be issued. There are no tangible assets or commodity backing the issuance of the currency/note.

By contrast, a $10 series of 1928 US currency bore the following statement: “Gold Certificate—this certificate is a legal tender in the amount thereof in payment of all debts, public and private—Ten Dollars payable to the bearer in gold coins on demand.”

In the 1900, with the passage of the Gold Standard Act, the US currency was secured by gold reserves. The gold standard was simply “a commitment by participating countries to fix the price of their domestic currencies in terms of a specified amount of gold. National money and other forms of money (bank deposits and notes) could be freely converted into gold at the fixed price.” A country under the gold standard would set a price for its gold, say $100 an ounce and would buy and sell gold at that price. This effectively sets a value for its currency.

In 1933 President Franklin D. Roosevelt outlawed private gold ownership by US citizens. After a big drop in US gold reserves and a large increase in foreigners' claims on US dollars, the US suspended the convertibility of its dollar currency to gold. The Bretton Woods System enacted in 1946 created a system of fixed exchange rates that allowed governments to sell their gold to the United States treasury at a price of $35/ounce. It further envisaged a system of convertible currencies, fixed exchange rates, and free trade that gave birth to the International Monetary Fund and the International Bank for Reconstruction and Development (now called the World Bank) and the General Agreement on Tariffs and Trade (GATT). By 1969 all countries had dispensed with internal circulation of gold and, in most cases, they did away with gold backing for their currencies.

The Bretton Woods system ended on Aug. 15, 1971, when President Richard Nixon ended trading of gold at the fixed price of $35/ounce. As the system of fixed exchange rates started to break down the US devalued its dollar twice and then gave up any further attempt to fix its price in terms of gold. At that point for the first time in history, formal links between the major world currencies and real commodities were severed and the currencies were allowed to float. The gold standard has not been used in any major economy since that time.

Central bankers of the world now use a variety of econometric models to measure and forecast various sectors of a country's economy so that they can stimulate or contract it to keep unemployment and inflation in check. In the U.S. for instance, there are several ways that the Federal Reserve Board expands the money supply, the primary tool used to contract and expand the economy. The most common is to buy back U.S. debt from commercial banks. The money that commercial banks collect from the sale of these government securities increases the amount they can lend. A second way is to loosen credit requirements, thereby increasing the amount of money generated by the banking system. A third way is to cut the prime lending rate, which is the rate the Federal Reserve loans to commercial banks. To reduce money in the economy, the Fed commits all the opposite actions. To fight unemployment, the Fed traditionally expands the money supply. This creates more spending in the economy, which in turn creates more jobs.

So long as the primary economic concerns of the central bankers of the world remain that of stimulating local employment and world trade while keeping inflation in check, exchange rates, interest rates and investment yields will continue to fluctuate worldwide, thereby creating differences in interest rates and yields in each country.

For instance, at the time of this writing, interest rates on a ten year loan in Japan was less than 1% per annum, while South Africa, for instance is paying investors a yield of 7.98% on its R153 government obligation with a buy-back repo (repurchase) rate of 7.00% per annum.

The realities of the local economy of a country and its balance of trade condition are usually reflected in the strength of the exchange rate of the currency and the prevailing central bank rates and retail bank rates. Because central bankers are required to adjust monetary policy to stimulate or contract local economies, there will always be differences in local interest rates charged by banks around the world and this will be reflected in the exchange rates of currencies. These differences will always continue to result in arbitrage opportunities between the various currencies of the world, and as long as such disparities between interest rates and yields exist, the present Technology will continue to present enormous opportunities.

There are several other factors that are important to understand as background to this invention.

Factor N° 1: Fiat money is essentially created from nothing for the reason that it is an unsecured promissory note of a government to pay based on the credit strength of a country and its economy. By comparison, a commodity-backed currency offers the benefit to its holder that it can be redeemed for a unit of that commodity (e.g. gold) on simple demand. Thus the sweat equity that fractionally contributed to the creation of wealth for a country could be acknowledged in the old days by a payment in gold coins produced in various denominations that was not dependent on how well the economy of a country was doing. By contrast, fiat money eliminated the individual transferable wealth creation nature afforded its owner by a commodity-backed currency and reduced the function of money to that of a settlement medium only (it is a means of transferring value for services rendered or goods purchased). Money has value simply because each citizen accepts its government unsecured promissory note as an acceptable method of compensation for individual productivity. When this happens, then money is simply reduced to a medium only good for the settlement of transactions and individuals have lost their ability to create tangible commodity-backed wealth. Fiat money looses all its value if individuals cease to accept it as acceptable and sufficient compensation for individual productivity.

Factor N° 2: In simplistic terms, after 1973 when countries ceased to use gold or silver to back their currency, it was decided that the combined production of the citizens of a country would be measured by that country's Gross Domestic Product (GDP) or Gross National Product (GNP) (or variations thereof). The gold standard would be replaced by a mathematical model which calculated in aggregated the productivity of its citizens and this would become the new security, or collateral, for a government's indebtedness. This model, in turn, would allow central bankers to calculate how much money to safely print and place in circulation to sustain the economy, without allowing inflation to get out of control. The objective of money production became that of stimulating employment and external trade while maintaining inflation in check. In one broad sweep, the legal nature of monetary currencies (or notes) changed with the result that on its face it only needed to say: “this note is a legal tender for all debts, public and private” (no more, no less than a medium for a government and its citizens to settle individual transactions or debt). The effect of this change was monumental and the long-term consequences hardly understood by the average citizen. A new system was born where printed money could only be exchanged for a like-kind piece of printed paper, meaning that a circular process had been initiated that could easily be controlled by central bankers and governments alike. In effect, the security offered by gold was replaced by mathematical formulas derived from the measurement of an economy so that the citizens of a country would become interdependent and reliant on each other to carry their fair share of wealth creation. This system created a method of total dependency of the citizens to support a country's economic development by contributing their sweat equity and grey matter, the primary contributors of wealth creation. If a particular currency devalues, all citizens are penalized for their country's poor economic performance or government mismanagement.

Factor N° 3: Retail bankers are normally members of a central bank and have access to all its services, including discounting facilities. When a bank customer purchases a $1,000 certificate of deposit, the issuing bank receives a cash deposit and issues a certificate that is redeemable at maturity. Having received $1,000 for a fixed term deposit, the bank is now free to lend that money at a rate that is usually several percentage points above the interest rate paid to its depositor. This spread differential represents the bank's profit.

Factor N° 4: Through a process known as discounting or “borrower in custody”, the bank can immediately regain its liquidity after having made a loan by pledging to the central bank or other money center banks involved in the inter-bank loan market (LIBOR or EUROBOR) its perfected security interest in the collateral it holds on loans. The cash liquidity it receives through this process can then be re-lent again at a profit which is the difference between the discount rate and the new loan placement rate.

Factor N° 5: Central banking regulations require each bank to maintain a portion of its cash deposits in its non-interest earning account at the central bank. This reserve set-aside is to protect depositors in case of a run on the bank. Larger banks are often required to maintain larger reserves than smaller ones due to increased liquidity risk. Bank reserves, also known as fractional reserves, are a tool of central bank monetary policy to tighten or loosen its credit policy; an increase in the ratio of required reserves to deposit indicates a tightening in credit policy by the central bank whereas the opposite indicates a desire to stimulate credit that results in economic expansion. A reserve requirement of 10% simply means that the bank can only lend out $90 on a $100 deposit ($10 is left on account at the central bank). When re-deposited in the bank by the borrower, the $90 loan proceeds qualifies as a new deposit which can be re-lent again at 90% ($81). This process can continue until a net zero effect is achieved. This “multiplier” effect of money is also referred to as leverage, because a $100 cash deposit can be leveraged into loans totaling $900, a net 9:1 leverage so long as the bank's capital ratios (Tier I and Tier II capital) are satisfactory. Therefore, significant profits are achieved by banks through this process of leveraging deposits and making loans at an interest rate greater than the cost of money. In each country, the reserve requirement is different, thus resulting in disparities between different economies in terms of the leverage afforded the banks. So long as different multipliers are applied throughout the world, opportunities will always exist to exploit and mine such disparities, as is demonstrated by this invention.

Factor N° 6: Banks profit by taking-in depositors funds which they then re-lend to borrowers. In that sense a bank is no more no less than an intermediary that is licensed to collect money from Party A and lend to Party B. Disintermediation can-result if Party A and Party B come together for the purpose of consummating a loan transaction where Party A is the lender and Party B is the borrower. In such a case, and assuming there is no middle-man, the normal bank spread which is the difference between the rate paid depositors and the interest rate charged on loans can be split between the parties with the result that the borrower's cost is reduced while the lender obtains a better rate of return on his investment. So long as the risk of non-payment is equal to or better than that of a bank's credit strength, such a transaction is highly desirable both from a lender and borrower's perspective.

Factor N° 7: As we have seen money is only a note of the issuer payable at redemption by another note of the same issuer and for the same face value. In this sense, the piece of paper called money is no longer a medium for wealth accumulation, it has been reduced to that of a medium of settlement that allows the holder to buy and sell goods and services with a piece of paper that everybody agrees has the value shown on its face. If the citizens of a country cease to ascribe the same value to a particular currency, that country's money will collapse and loose its value as a medium to settle barter transactions.

Factor N° 8: Central bankers hold a license to print a country's money which they then place in circulation to support the economy of that country. They make money by charging interest on paper money which initially cost little or nothing to put in circulation—only the cost of the paper and printing. Thus central bankers have a free reign to issue redeemable notes that have little or no real value, but that everybody accepts as valuable.

Factor N° 9: When a corporation issues and sells a note into the capital market (e.g. a senior unsubordinated note), it is in effect creating cash liquidity that flows to its balance sheet. There are two primary types of notes, with interest coupons or without interest coupons (also known as zero coupon notes). Notes are essentially fixed-income instruments that pay interest quarterly, semi-annually or annually and that are sold at a discount or at a premium based on the prevailing interest rate. At maturity the note holder redeems it for cash equal to the note's face value. In the case of a zero-coupon note, it is purchased at a deep discount relative to its face value. For instance, if the 10 year treasury yield is 4.2% p.a., a ten year zero-coupon note will sell at 66.25% of its face value. The interest is then collected in full when the instrument is redeemed at maturity.

Factor N° 10: A note is for all practical purposes a security instrument, an industry which is highly regulated by local governments. It is therefore necessary for a prospective issuer to surround himself or herself with extensive legal and tax counsels which can cost as much as hundreds of thousands of dollars. For this reason, the issuance of notes is often out of reach for many small corporations and individuals who might be tempted to issue notes to raise cash.

Factor N° 11: If one attempts to arbitrage the differential that exists between a high investment yield achieved in a particular country (e.g. South Africa with a 7.98% current annualized yield) and a low refinancing (loan) rate offered in another (e.g. Japan with less than 1% current interest rate), prudence would require the establishment of a forward currency hedge to eliminate the long-term currency fluctuation exposure risk. In this case, the foreign exchange futures markets are so efficient that the cost of such a hedge will almost certainly wipe-out all the benefits achieved in the arbitrage attempt. However, if it is possible to close a transaction that is then quickly reversed through a repo process, the hedge needed for a very short term currency risk exposure will leave most of the profits from such an arbitrage intact and substantial profits can be achieved.

Factor N° 12: Loans usually carry an annual interest rate computed on the outstanding balance due the lender. Similarly an investor who is willing to invest his funds by purchasing a financial instrument (e.g. a certificate of deposit from a bank) will be guaranteed a fixed or variable rate of return on his investment. In the first case the interest paid on a loan is a cost to the borrower while it is an income to the investor on the purchase of the financial instrument.

In both cases the future values of payables or receivables can be reduced to their respective present values using the following formulas in an Excel spreadsheet:
PV*(1+Rate)^{nper}+pmt(1+Rate*type)*(((1+Rate)^{nper}−1)/Rate)+FV=0
V(rate,nper,pmt,fv,type)
Rate is the interest rate per period.
Nper is the total number of payment periods in an annuity.
Pmt is the payment made each period and cannot change over the life of the annuity. Typically, pmt includes principal and interest. If pmt is omitted, the fv argument must be included.
Fv is the future value, or a cash balance that needs to be attained after the last payment is made.
Type is the number 0 or 1 and indicates when payments are due.

Because of the competitive nature of the banking industry and the regional and international interest rate fluctuations that result from economic decisions of the world's central bankers to address economic trends, there exist international arbitrage opportunities (interest rate differentials). However, such opportunities are usually non-existent within the same currency and/or country. Central bankers eliminate such arbitrage opportunities through a mechanism that makes the cost of borrowing in a particular currency greater than the investment yield available in that same currency.

However, central bankers have not been able to eliminate arbitrage opportunities between currencies and these will always continue to exist. For instance, at the time of this writing, it is possible to invest in South African Rand in the Government's R153 (Treasuries) at an interest rate of 8.18% that has a repo rate of 7.5% while borrowing rates in the US or Japan are well below that rate.

Even though arbitrage opportunities are rarely, if ever, available in the same currency, this invention shows how synthetic arbitrage opportunities can be created with the help and/or cooperation of the banks that wish also to derive a benefit from the process. Using this invention, the opportunity is artificially created while eliminating all transactional risks and/or hedging requirements normally required in arbitrage transactions between currencies and or international interest rates.

The purpose of this invention is to show how an arbitrage opportunity can be created even at the retail banking level through the process described herein, which is the object of this invention. So long as there are at least four participants working together, but independently of each other, to accomplish a common objective such arbitrage opportunities can be created.

### SUMMARY OF THE INVENTION

The Invention relates to the creation of a two-tier (one at the retail level and one at the wholesale level, for institutions only) global electronic exchange that facilitates the online interaction of individuals, institutions, or corporate entities and provides a platform to instantly close and settle interest rate or yield arbitrage transactions online. The system provides a variety of secure online fiduciary services to a clientele that is interested in either raising money to finance projects or making a pre-defined trading profit in arbitrage opportunities. Clients sign-up electronically to participate in pre-arranged methods of cooperatively mining differentials between the present values of investment yields and interest rates achieved on refinancing within a single currency, between different currencies or based on a freely convertible and indexed unit of exchange (e.g. a casino chip that has a pre-set value attributed to it and is freely exchangeable for cash) that is indexed on the original investment currencies used by the participants to enter their bids. All transactions on the exchange are undertaken on a fiduciary basis and designed so as to: (a) eliminate the risk of loss of investment principal, and (b) deliver a profit to each participant each time the prescribed process is applied in a systematic fashion in a series of simultaneous online escrow closings. Using the system's electronic features, transaction participants are instantly able to issue, securitize, sell, trade, refinance, repurchase (repo) notes or loans or create synthetic products through an electronic bid system that allows bids to be submitted by worldwide participants for either investments (e.g. the yield to maturity desired by an investor), secured loans (e.g. the interest rate desired by a lender) or the repurchase or reverse repurchase of instruments or loan portfolios. The system receives and calculates all bids in order to create the financial products and it automatically matches the yield to maturity and interest rate bids for all the transaction components in order to create an instant transaction closing that involves the online issuance and sale of a series of financial products, loan portfolios and refinancing strategies based on the successful bidding parameters so as to produce a profit for all participants in the closing.

As explained in Diagram 1, the system can also be viewed as an electronic disintermediation system that allows investors and lenders to come together within the context of a global electronic exchange in order to bid for a share of the profits that would normally accrue to banks when they: (a) lend depositors funds at a higher interest rate than they offer on deposits; (b) refinance loan portfolios through the discounting, forfaiting or reverse repurchase process used to liquefy loan portfolios at an interest rate lower than that of the loans; (c) engage in the issuance, sale and repurchase of financial products they can buy back and retire off their books at a profit. It is also a system that banks and financial institutions can use either at the retail or wholesale level of the exchange with great advantage to gain new customers, accelerate deposit and loan growth, engage in treasury operations, create and sell financial products worldwide online, create hedges, swap currencies and cash flows, engage in repo and reverse repo strategies, maximize tax advantage by shifting earnings to areas of the world that offer a more attractive taxation structure, strengthen balance sheets at critical times, legally reallocate profits between overseas branches etc.

### DESCRIPTION OF THE DRAWINGS

Diagram 1A describes how banks make a profit by: (a) lending depositors' funds at a higher interest rate than they pay on deposits; (b) refinancing their loan portfolios through a process known as discounting or forfaiting which is designed to liquefy an illiquid receivable at an interest rate which is lower than that of the loans; (c) engage in treasury operations through the issuance, sale and repurchase of financial products at a profit. The diagram further illustrates how a dynamic and efficient exchange can be created to facilitate the bidding process so that an efficient global marketplace is created to instantly issue, sell refinance and retire notes (with or without coupons) in such a way that a profit can be made by each of the disintermediation model participants. This model, when in full implementation mode worldwide, will create a dynamic interactive bidding process that will have a tendency to narrow the profit margin between the lending/borrowing rates and the discounting rates with the result that a more efficient method of establishing market-driven rates will ensue. The diagram illustrates how, for example: (a) a depositor can earn a better investment return (4% yield to maturity) by depositing funds into the exchange instead of at the bank (3%), (b) borrowers have an advantage to borrow (5% interest) from another exchange participant rather than from the bank (6%), and (c) more sophisticated discounters or forfaiters (institutions operating at the wholesale level) can profit from making discount loans at a better than market rate. The diagram illustrates how all the parties involved in a disintermediation process benefit in the end.

Diagram 1B describes the process used by participants to open an account online, to deposit local currencies in a trust sub-account, to convert the local currency deposit into credits expressed in transaction units (“TUs”) used to create a standard trading platform for all currencies, and to submit bids to participate in a pre-defined transaction process and specification that will produce a profit for all successful bidders at closing, as described herein. The diagram also describes how: (a) a note can be instantly issued simply by executing a one page adoption agreement that adopts a complex and extensive standard set of pre-established supporting legal documents for a precisely defined issuance and sale of a note between a note issuer and a note purchaser; and (b) a secured loan can be instantly closed by both parties simply adopting a standard set of pre-established legal documents that support a precisely defined refinancing transaction between a lender and a borrower. The system offers two separate bidding platforms that include two sub platforms and a separate repo & swap platform operated behind the scenes for institutions at the wholesale level of the exchange, as described further on. The first position involves a bid to issue and sell a note at the successful bid price expressed as a desired yield to maturity. The second position involves a bid (expressed in terms of the desired yield to maturity for the duration of the investment) to invest funds by buying the above note at the successful bid price. The third position involves a bid (expressed in a desired annual interest rate) to refinance (liquefy the above investment) the note that has been acquired through the above process and where the loan principal is guaranteed by the note principal due at maturity and the interest payments are guaranteed either by the coupons attached to the note or by the creation of a sinking fund held by a fiduciary agent in which the present values of all future cash flows are deposited to service the interest payments during the life of the loan. The fourth position bidding to make a loan for the refinancing envisioned in position number three above, with each of the four transaction closings occurring simultaneously through escrow. As is explained further herein, this invention results in an exchange where “bid” and “ask” tenders are submitted to produce the five closing components that will result in a profit for all participants.

Diagram 1C shows how corporations, financial institutions, individual investors, traders and agents in various parts of the world can submit their bids to participate in a transaction closing. The system describes how bids are accumulated from worldwide bidders on the basis of either a yield to maturity desired on cash available to invest or interest rate desired for loans or refinancing strategies, and how the successful bids are selected on the basis of the techniques further described in Diagram 3 attached hereto.

Diagram 2 explains how successful bidders in the four main platforms of the exchange described in Diagram 1A, 1B and 1C above can each borrow through local banks, in their local currencies (in currency pairs) at a rate that allows them to make a profit in addition to what they can potentially make on the exchange. This process of discounting at a lower rate is similar to those used by banks to liquefy assets through borrowings done in the inter-bank market (e.g. LIBOR or EURIBOR) or through the “Borrower in Custody” programs offered by most central bankers of the world as explained in Diagram 1A (the right side of the diagram).

Diagram 3 describes how YTM bids (Yield to Maturity bids for investments in a note or bond) and IR Bids (Interest Rate for refinancing or discounting loans) are matched in the exchange in order to instantly create the products and the refinancing mechanisms that allows a transaction to close with a pre-defined profit accruing to the benefit of each successful bidder at closing. The diagram shows how the YTM and IR bids are picked on the yield scale: For a refinancing or discounting, the system starts by accepting the lowest and highest bids made on the exchange based on the principal that a profit is achieved by refinancing an investment portfolio at a lower interest rate than its yield to maturity, and vice versa by refinancing a loan portfolio at a lower interest rate that than of the loan. Based on this principal, the system is designed to add the “differential to Achieve the YTM in the Repo Bid” to the lowest interest rate bid. It then does the same thing at the top end of the scale, where this time it reverses the process. The system then accepts and locks-in five separate successful “bids” and “asks” that are then grouped into three simultaneous closing batches: (1) the average of the bid and ask yield for the issuance of a [e.g. ten years] note; (2) the average of the bid and ask interest rate for a fully defeased [e.g. ten years] refinancing loan (secured by either cash or cash-backed notes); (3) the lowest refinancing interest rate bid offered by a repo/swap counterparty (lowest interest rate available for the term of the note).

Diagram 4 shows the same scale as in Diagram 3 but this time it adds the complexity of simultaneously closing similar transactions between country pairs, with the added possibility that the portfolio of notes and loans of closed transactions between countries (country pair: B & Z) can be swapped for those of another country pair (A & X).

Diagram 5 illustrates the returns and benefits achieved by each party in a series of transaction closing that are repetitive in nature and that involve an investment yield to maturity of 8% p.a. and a 4% refinancing rate and a 96% loan to value. Activity Blocks 1 and 2 describe the following processes: Investor #1 deposits 1,000,000 Transaction Units (TUs) in his trust trading account in his host country. He borrows 1,000,000 TUs from Party B and pledges his TUs on deposit as collateral [5]. He prepays the interest on the Loan by deducting 211,607 TUs [6] from the loan proceed (the cumulative total of all Present Values of all annual interest payments due on the loan based on a loan interest of 4% p.a. and a similar yield of 4% on the deposit). Investor 1 then takes the proceeds obtained from the Loan of Party B and uses 728,193 TUs from it to acquire a 1,000,000 TU, ten (10) year senior secured note issued by Party A that has a 4% coupons payable semi-annually over ten years at a discount rate of 72.28193% of face value) [8]. Investor 1, pledges this 1,000,000 TU Note in favor of Party B in exchange for a secured loan of 960,000 TUs at an interest rate of 4% p.a. payable semi-annually in arrears (the loan is secured by the note principal due at maturity while the semi-annual interest payments are secured by the 4% coupons attached to the note) [9] and [10]. Investor 1 once again deposits the refinancing proceeds of 960,000 TUs in his trust account and buys another 10 year senior 4% coupon note issued by Party A at a cost of 728,193 TUs [11]. The cycle of buying and refinancing between Investor 1 and Parties A & B continues until such time as the bids of one of the parties is satisfied or one of the parties ceases to close additional transactions. More importantly, the diagram illustrates how a mirror process is duplicated in reverse by Investor #2 in Activity Blocks 3 & 4. In this case Investor #2 buys the notes of Party A and refinances with Party A, the reverse of what Investor #1 did. This process is essential in order to position all the transactions for a swap or repo through the wholesale platform of the exchange (is accessible only by the institutions) that produces a profit or a benefit for all concerned.

Diagram 6 illustrates the same identical cross-over investment and discounting mechanism as in Diagram 5. However, this time, instead of using notes that carry a fixed coupon rate sufficient to pay interest, when due, on the refinancing loan, the process calls for Investors #1 & #2 to only invest in zero coupon notes issued by Party A & B and which they then use to secure the principal due at maturity on the refinancing of mirrored transactions. In this case the interest payments due on the loan refinancing are covered by the deduction of an amount sufficient (at the present value) to cover each and every interest payment due over a ten (10) year period. This amount is deposited in a sinking fund (managed by a fiduciary) that is invested in the worst case scenario at the same rate as the loan interest rate.

Diagram 7 summarizes the account balances of the four principal transaction parties after an initial borrowing (steps [5], [6] and [7] of Diagram 5) followed by three identical and consecutive complete trade cycles (steps [8], [9] and [10] of Diagram 5) that closed successfully. The top part of the diagram is a summary of account balances based on assumptions used in Diagram 5, whereas the bottom part of Diagram 7 is a summary of account balances based on assumptions used in Diagram 6. As an example (use the top diagram—without sinking fund) after 3 and one half closing cycles, Investors 1 and 2 who each invested a total of 2,000,000 TUs, now have a mirrored 2,483,000 TUs (a 24% return on investment) in their respective accounts, whereas Party A and Party B each have invested at the onset 4,000,000 TUs to make loans totaling 3,880,000 TUs which are secured (fully defeased) by TU-backed secured notes having an aggregated face value amount of 4,000,000 TUs. What this invention demonstrates is that all four parties have benefited from the closings that were engineered in accordance with the requirements of the successful bids. The investors received a short-term (one closing a day—3 days) 24% return on investment and they walk out of the deal with no loans that must be repaid since all refinancing in the Technology is on a non-recourse basis. Party A & B on the other hand who have more longer-term objectives each have built a 4,000,000 TU loan portfolio that is fully secured by each other's debt instruments while retaining a TU balance of 3,516,188 each at the end of the 3-½ cycle process. In other words, Party A and Party B will each have financed a 4,000,000 TUs secured loan portfolio with a net cash outlay of only 483,812 TUs that they can choose to retain on their books to maturity or that they can swap, securitize by issuing and selling derivative instruments, or refinance at any time they so desire. Depending on the interests and strategic objectives of each party in the transaction, the Technology can potentially be used to accelerate the accumulation of a portfolio of high-grade secured loans, engage in treasury operations, create hedges and currency swap opportunities, engage in repo and reverse repo strategies, maximize tax advantage by shifting earnings to areas of the world that offer a more attractive taxation structure, strengthen balance sheets at critical times, and legally reallocate profits between overseas offices.

Diagram 8A illustrates what a Master Note will look like when presented on screen to confirm a closing. In this case the successful bidders are identified together with their respective account numbers together with the terms and conditions of the closing and the settlement price achieved by the successful bidder.

Diagram 8B explains how a $1,000, 10 year zero coupon note that has a yield to maturity of 5% p.a. needs to be accounted by the buyer and the seller. The issuer/seller of the note receives $610.27 and transfers a note having a face value at maturity (10 years) of $1,000. The issuer then annually books an interest expense that accumulates to $1,000 at the end of the 10^{th} year. The holder/buyer of the note on the other hand pays $610.87 to purchase a note with a face value at maturity of $1,000. Holders of a 10 year note are then required to annually accrue an interest income receivable at maturity. Zero coupon notes are ideal instruments to secure (and fully defease) the principal repayment portion of a loan at its maturity since the maturity date of the zero coupon can be made to coincide with the maturity date of the maturity of the loan.

Diagram 9 illustrates the Account Opening process for a person or an entity anywhere in the world to become an account holder authorized to submit bids and close transactions on the exchange following a compliance approval process described in steps [5] through [10]. Of importance in this Diagram are steps [13] through [19] which explain a process by which the adoption of standard pre-defined contracts will permit the exchange to dynamically and instantly create closing documentation for simultaneous online escrow closings, including notes, note purchase agreements, loan agreements, swap agreements, refinancing agreements, repo agreements, etc. Following the adoption by the new applicant, of all the applicable forms of agreement that govern transactions the new bidder is likely to engage in, the account will be approved for trading whereupon the new account holder will be required to make a deposit (in his local currency) to a trust account (fiduciary) in his home country to secure 100% of his anticipated trading activities on the exchange. Based on pre-defined strategies (investments or loans), the system will select and present for adoption all necessary legal forms to the new applicant. Steps [19] through [23] describe a process by which the new participant on the exchange converts his local currency deposit into TUs or TU-equivalents for trading purposes. Steps [24] through [27] describe a process through which a dynamic link can be created between the TU-denominated account and a Trust-linked Debit Card (which is the object of a separate patent application of this inventor) so that the TU account can be accessed and debited for debit transactions made on the card. In this case, each time a debit is made on the card at an ATM or at a merchant location, sufficient TUs are converted into local currencies in order to allow the debits to be immediately settled. This feature is the subject of a different but related U.S. Non-Provisional Patent application Ser. No. 60/630,233, filed Nov. 22, 2004 referenced above in the section “Cross Reference to Related Applications” section.

Diagram 10 describes the inter-relationships between the parties involved in the deployment of the Technology. Steps [1] through [6] describe the fiduciary, custodial, and accounting relationships necessary in each country of the world so that performance transaction completion guarantees can be provided to accommodate the issuance of notes, the holding of sinking funds, the maintenance of account deposit balances in local currencies or TUs, etc. and to provide third-party fiduciary agent protection to each and every transaction consummated on the exchange. Steps [6] through [13] describe the method by which the present Technology can be dynamically linked and interfaced with the Trust-Linked Debit Card Technology referred to above. Steps [14] through [20] describe the bid platforms and their relationships to the other components of the Technology.

Diagram 11 explains the process used to: (a) submit a bid on the exchange expressed either as a “desired yield to maturity” on an investment or a “desired interest rate” for a loan or refinancing transaction, (b) aggregate and analyze all bids received, (c) prioritize and match the bids for delivery of four accepted bids at a time into bid buckets referenced [13A] or [14A] in the case of a note, and [13B] or [14B] in the case of a loan so that a transaction can instantly and seamlessly be closed on the exchange. Steps [15] through [18] describe the process of instantly calculating the parameters of the transaction and converting both an accepted bid to borrow (issuance and delivery of a promissory note) and an a bid to make a secured loan (issuance and delivery of a non-recourse loan agreement) into finished products that can be bought and sold on the exchange through a simultaneous escrow closing process. Steps [19] through [21] describe the transaction closing process and the distribution and posting of profits to the account of the successful bidders.

Diagram 12 (top half) illustrates the process of indexing a particular local currency to a base TU unit (in this case the unit is gold) measured from a baseline of $475.00 an ounce. For instance, in this case a $475/oz gold rate will yield a 1.00 US Dollar exchange rate. If the value of gold increases to $490/oz, the US Dollar TU index will increase to 1.0316. In this illustration, the inter-relationships between currencies is simply based on the exchange rate relative to the baseline unit. On the opening day of the exchange all currencies of the world will be converted into a baseline Transaction Unit value that will be based on the gold value and the inter-relative values of the currencies at that time. This value will become the baseline from which all TU values will henceforth be derived. For instance, if the baseline is $1.00=1.00 TU when gold is at $475 and the Euro is at 0.8566 based on its value relative to the dollar on that day, the Euro acquires on that day a baseline value of 0.8566 TU. If the price of Gold increases to $490/oz, Euros will be converted into TUs at the rate of 0.8837 on that day.

Diagram 12 (bottom half) describes the parameters the system needs to convert yield to maturity bids into a discount price of a note and to incorporate the coupon rate (the anticipate interest rate of the refinancing) in the calculations. To calculate the Discount rate of a note expressed as a percentage of the face value of a note, we use the following Excel spreadsheet formula:=PRICE([Purchase Date], [Maturity date], [Coupon Rate], [Desired Yield to Maturity], [Redemption Price], [Coupons payable annually or semi-annually], [Day-Count: 360 or 365]). The interest rate of the refinancing (the successful bid rate) automatically becomes the coupon rate of the note if a coupon note is desired. Otherwise, in the case of a zero coupon note, the percentage entered is 0% as the coupon value.

Diagram 13 (followed by its continuation illustration, Diagram 14) illustrates the method of matching and allocating the successful yield to maturity bids and interest rate bids into the four transaction buckets (steps [3] through [6]) that can be closed through a simultaneous and instantaneous escrow closing process executed electronically in seconds (steps [7] and [8]). When the four parties' transactions are closed simultaneously and the settlement (step [9]) is distributed immediately, such closings will result in a profit or a benefit to accrue to each successful bidder as illustrated herein. Steps [9] through [11] explains what happens for each set of separate (but related) closings and the inter-relationships of the parties (unrelated entities) to create mirrored transactions that can later be reversed (through a repo) or swapped at the appropriate time to suit an investor or a lender's specific objective.

Diagram 14 is a continuation of Diagram 13. It describes the process of closing two simultaneous escrow transactions (steps [12] and [13]). Steps [14] through [19] describes an optional and additional process of executing a third transaction closing involving Party C repurchasing the entire portfolio of Parties A and B at a pre-set price so that matching assets and liabilities of Party A and Party B can be reversed fully or partially. For instance, if Party C wishes to swap the notes of Party.

Diagram 15 describes the bid buckets and the method of allocating bids to these buckets. The mirrored process is essential to allow profits to flow to the investors and to allow the banks later to retire their loans through swap arrangements or other methods implemented at the wholesale level of the exchange.

### DESCRIPTION OF THE PREFERRED EMBODIMENT

Preliminarily, the percentages, amounts, numbers, rates, etc, recited in this specification are for illustrative purposes only and do not reflect what is optimally or minimally achievable under the invention. Each transaction involves its own set of particulars and numbers that can be calculated with accuracy prior to a particular closing.

Also preliminarily, the invention is referred to below as the Invention and/or the Technology.

Also preliminarily, a glossary of the terms used in the present application follows.

The term “arbitrage” describes the process by which a profit is achieved through a positive advantage derived from an investment yield greater than the refinancing cost, and the application of time value of money calculations to reduce future cash flow streams to their present values. As used herein an arbitrage advantage also exists in cross currency investments and refinancing (e.g. an investment is made in Mexican Peso with a yield to maturity of 10% per annum while a refinancing is simultaneously executed in Japanese Yen at 1.5% per annum, and a shorter term currency hedge is placed to eliminate currency fluctuation risks just to cover the period between the closing and the repo/swap process envisioned herein). The term arbitrage is also used herein to describe the yield advantage that financial institutions derive between the retail lending rates and the (wholesale) inter-bank discount rates for refinancing (refer to “fractional reserve banking” below).

A “beneficiary” (or a “Trust Participant” in the case of a Participation Trust) means a Person who owns a fraction of the Trust Estate as evidenced by Trust-Issued Receipts, Trust Notes or Trust-Participation Receipts, in pro-rata of his total holdings relative to the total Trust Estate.

A “bond” is an interest-bearing or discounted security that obligates the issuer to pay the bondholder a specified sum of money, usually at specific intervals, and to repay the principal amount of the loan at maturity. Bonds are normally backed by collateral but can also be based on the credit strength of the issuer.

A “bridge lender” is a party that makes a bridge loan (or swing loan) in anticipation of a short, intermediate or long-term refinancing which is sure to occur in the future.

A “bridge loan” is a loan made available to a borrower by a Bridge Lender in anticipation of a more definitive refinancing which is sure to occur. The “bridge” can be for anywhere from a few hours to several months.

A “cardholder” means any Person who is the holder of a Trust Sub-Account and who, by virtue of having adopted a Trust Agreement in which he is a beneficiary, has received a Trust-Linked Debit Card (see below).

A “central Bank” is a country's bank that (1) issues currency; (2) administers monetary instrument, including open market operations; (3) holds deposits representing reserves of other banks; and (4) engages in transactions designed to facilitate the conduct of business and protect public interest.

A “collateral” is an asset pledged to a lender until a loan is repaid. If the borrower defaults, the lender has the legal right to seize the collateral and sell it to pay off the loan.

A “collateral trust note” or “collateral trust bond”—see credit derivative.

A “coupon” is a detachable certificate showing the amount of interest payable to a bond or note holder at regular intervals, ordinarily semi-annually. Bond interest on book-entry securities is credited to the owner's account.

A “coupon rate” is the nominal annual rate of interest the issuer of a note or bond promises to pay the holder during the period the securities are outstanding.

A “counter-party” is the person at the opposite side of a repurchase (repo) agreement or swap agreement. The person who agrees to sell back securities sold in a repurchase agreement, or exchange at a later date currency values or interest rates in a swap agreement with another party.

A “counter-party risk” is the credit risk associated with a particular counter-party.

A “credit-derivative” (also known as a “collateral trust note” or “collateral trust bond”) is a debt security backed by other securities, usually held by a bank or other trustee. Such notes or bonds are usually backed by collateral trust certificates and are usually issued by parent corporations that are borrowing against the securities of wholly-owned subsidiaries.

A “credit-linked note” is a credit derivative which allows the issuer to set-off the claims under an embedded credit derivative contract from the interest, principal, or both, payable to the investor in such note. The credit risk of a credit-linked note is the same as that of the issuer risk associated with the underlying asset pool.

The term “currency” means any lawful money of a country issued by that country's Central Bank. In this example we have used the United States Dollar as the currency of choice, but the invention is applicable to any currency.

A “custodian” means a bank or securities firm that is designated to act as custodian for Available Funds of the Trust and other Trust Funds.

A “debt instrument” is a written promise to repay a debt, evidenced by an acceptance, promissory note, or bill of exchange. The term also applies to formal debt securities such as bonds and debentures.

The terms “defeasance” or “defeasement” apply to a refinancing technique in which a note or bond issuer, instead of redeeming the instruments at the call date, continues to make coupon interest payments from an Irrevocable Trust and has deposited into the trust assets that will be used for the repayment of principal at maturity. The cash flow from trust assets, ordinarily U.S. Treasury securities or zero-coupon securities, must be sufficient to service the instruments until the expected maturity. Defeasance effectively removes the instruments from the issuer's balance sheets, even though the issuer continues to meet bond interest payments. For the purpose of this invention defeasement is used in the sense that any and all risks associated with the debt service (principal and interest) has be shifted to the issuer of the instruments that are part of the portfolio of collateral with the resulting benefit that the credit risk for the lender is not based on the balance sheet strength of the transaction manager, but on that of the issuer of the collateral.

A “defeased loan” means a loan in which the credit risk associated with a particular loan has been shifted from that of the borrower's financial strength to a 100% reliance on the credit risk associated with the issuer of the securities or debt instruments offered as collateral in a secured loan transaction. In this invention a defeased loan refers to the process of offsetting the debt service obligations of the borrower (through a security/pledge & assignment) with the income to be earned from one or more securities of a third-party issuer that provides 100% of the cash flows necessary to meet any and all debt service obligations of the borrower to the lender.

A “derivative instrument” is a contract whose value is based on the performance of an underlying financial asset, index or other investment. For example an ordinary option is a derivative because its value changes in relation to the performance of an underlying stock.

The term “discounting” (or “rediscounting”) means the process by which a credit is obtained by a financial institution through the pledge of its collateral (e.g. notes, acceptances, etc.). A bank can refinance its collateral portfolio through the process known as discounting as is the case in the “Borrower in Custody” program of the Federal Reserve Bank of the United States or through the inter-bank loan market (e.g. “LIBOR” or “London Inter-Bank Overnight Rate”). Discounting is also the process of estimating the present value of an income stream by reducing the expected cash flow to reflect the time value of money. Discounting is the opposite of compounding.

A “discount rate” is the interest rate the Central Bank (e.g. the Federal Reserve Board) charges member banks for loans, using government securities or eligible financial instruments as collateral.

A “discount”, when used in respect of bond or note normally refers to the price of the instrument expressed as a percentage of the face value (see below). When it is said that a bond is sold at a discount it refers to a price below 100% of face. Similarly, a premium is any price paid that is above 100% of face. Bond prices rise when interest rates fall and prices decline when interest rates go up.

The phrases “escrow assets” or “simultaneous escrow closing assets” represent the money, securities, or other property or instruments held by a third party (e.g. a law firm or title company acting as the escrow agent) until all the conditions of a contract are met whereupon the “escrow” closes and the assets held in safekeeping are distributed to each party in accordance with the terms and conditions of the contract. In the case of a simultaneous escrow closing, all conditions must be met before the escrow can close. The following terms and conditions usually apply in such cases: “The delivery of the instrument and payment of the purchase price and the closing shall be simultaneous in that neither the delivery of the instruments, payment of the purchase price nor any event required by the terms of this Agreement to occur thereat shall be deemed to have occurred until such delivery, payment and all such events shall have occurred, and when such delivery, payment and all such events have occurred, they shall be deemed to have occurred simultaneously. In the event the closing does not occur within X business days of the scheduled closing date, all funds, instruments and other assets held in escrow will be immediately returned to the original depositor.”

The “face value” of a bond, note, or other security is the value given on the face of certificate or instrument.

A “floating trust-participation receipt” is a Trust Participation Receipt that is initially delivered to a Trust Participant to evidence that party's beneficial interest at any point in time in the Trust Estate to the extent of his holdings therein. Since a Participant's account balance will fluctuate daily when deposits and withdrawals are posted, the receipt amount evidencing available funds on account is floating as defined in the receipt certificate. Therefore, rather than being for a set receipted amount, such Floating Trust-Participation Receipt, when issued and delivered upon the opening of a Participant's Trust Sub-Account, will establish the method and basis of calculating, booking and reporting the balance of a Sub-Account at any point in time. “forfaiting” is a method of financing (with fixed or floating interest rate) that eliminates all risks by selling a receivable on a “non-recourse” basis in exchange for immediately available cash.

The phrase “fractional reserve banking” is the method by which banks that are members of a Central Bank are required to maintain a fraction of bank depositors' funds in a non interest-bearing account as a “reserve” to pay-off depositors in the event they demand their funds back. This simply means that a bank can lend out $10,000 for every $1,000 maintained on deposit (10:1 leverage). Banks are further required to maintain a healthy Tier I (100% at-risk capital of the bank) and Tier II (bank capital that is not 100% at-risk, e.g. capital that includes an element of priority, preference or return guarantee) capitalization levels. Central Banks use Fractional Reserve Banking as a money multiplier in the economy e.g. Bank A receives deposits of $100 and lends out $90 which the borrower X then deposits at Bank B. Bank B receives $90 and lends out $81 to borrower Y, etc. until there is a zeroing out occurs in the economy. The practical application of this principle is that banks profit significantly by applying two principles of banking: (a) the leverage (currently 10:1 in the USA; 20:1 in Canada; 12.5:1 in Europe, etc.) of depositor funds that can be loaned or invested (e.g. loans to the government through the purchase of Treasury instruments) as explained below, and (b) the Discounting or Rediscounting at an interest rate that is lower (wholesale rate) than the rate at which finds are lent or placed into the market (retail rate). The compounding of Leverage and Discounting results is massive profits for the banking industry, assuming, of course, that loan defaults are maintained at a reasonable level.

A “full transaction cycle” means an arbitrage transaction that has closed and settled successfully and has been followed by a second closing and settlement that mirrored in reverse the first closing. If a note is bought, and cash is expanded to acquire the note, then a secured, non-recourse refinancing of the note must occur to return liquidity to the exchange and leave an arbitrage profit to the participant. Likewise if a note is sold, the second transaction must involve the reinvestment of the note sales proceeds to return the liquidity to the exchange.

A “future value” or “FV” refers to a formula that returns the future value of an investment based on periodic, constant payments and a constant interest rate. In other words, it is the future value, at maturity, of an income stream or an investment made today based on a compounded rate of interest. To calculate the Future Value of a present day investment the formula FV (rate,nper,pmt,pv,type) [e.g., formula used in a Microsoft Excel™ spreadsheet] will return the Future Value of an investment, in which:

Rate is the interest rate per period.

Nper is the total number of payment periods in an annuity.

Pmt is the payment made each period; it cannot change over the life of the annuity.

Typically, pmt contains principal and interest but no other fees or taxes. If pmt is omitted, the pv argument must be included.

Fv is the present value, or the lump-sum amount that a series of future payments is worth right now. If pv is omitted, it is assumed to be 0 (zero), and the pmt argument must be included.

Type is the number 0 (end of period) or 1 (beginning of period) and indicates when payments are due.

An “interest rate swap” is a contract in which two counter-parties agree to exchange interest payments of differing character based on an underlying “notional principal” amount that is never exchanged. There are three types of interest swaps: “coupon swaps” or exchange of fixed rate for floating rate instruments in the same currency; “basis swaps” or the exchange of floating rate for floating rate instruments in the same currency; and “cross currency interest rate swaps” involving the exchange of fixed rate instruments in one currency for floating rate in another. In its simplest form, the two contracting parties to an interest rate swap exchange their interest payment obligations (no principal changes hands) on two different kinds of debt instruments.

An “instrument” in general refers to the debt instruments of an issuer.

An “internal rate of return” or “IRR” is the average annual yield earned by an investment during the period held. In a financial instrument the IRR is equal to the “Yield to Maturity” as defined below.

An “investment cycle” or “cycle” refers to a series of transaction closings that specifically include the purchase of an instrument followed by a refinancing. Cycles can be repeated at will.

The “issuer” or “original issuer” is a corporation, government or other legal entity having the authority to offer its bonds, notes, or stock certificate for sale to investors.

The “lending rate” is the annual interest rate charged on a loan.

The term “leverage” in finance means the money that is borrowed to increase the return on invested capital. In banking it is the use of funds purchased by a bank in the money market or borrowed from depositors to finance interest-bearing assets, principally loans. Banks invest their depositors' money in loans at rates high enough to cover the lender's cost of funds and operating expenses, and yield a profit margin or spread. In finance it is the use of debt or senior securities to get a higher return on owner's equity capital. In banking, leverage is also the amount that a bank can lend out with the refinancing support of its Central Banker, money center banks, home mortgage refinancing institutions or the global inter-bank refinancing markets (e.g. London Inter-Bank Overnight Rate—“LIBOR”) based on the bank's balance sheet capital reserves. [In the United States for instance, a bank can lend out $10 for every $1 of capital reserve it maintains on its books. Banks profit from a leveraging process by: (a) lending available cash at retail interest rates followed by a refinancing (or discounting) of the collateral at a lower discount rate; (b) repeating this lending and refinancing cycle until such time as the full 10:1 leverage has been achieved as permitted by the Central Bank. As an example, a bank that receives a $1 million proceeds for the sale of a ten-year financial instrument can achieve a gross profit of $1.09 million over the same ten year period, assuming a leverage of 9 times proceeds, a cost to the Issuer of 6.25% interest per annum, a reinvestment of 50% of the proceeds in US Treasuries and 50% in retail mortgage, a revenue yield to maturity of 4.15% on US Treasuries, a revenue yield of 5.87% on mortgage loans, and a bank refinancing rate of 2.75%.]

The “loan to value” is the amount loaned (the principal) relative to the face value of the supporting collateral, e.g. a loan of $900 secured by securities having a $1,000 face value represents a 90% loan to value.

A “master trust” means a Trust which itself is the sole beneficial owner of 100% of the Trust Estate of other similar trusts.

A “money center bank” is a bank located in a major financial center that participates in both national and international money markets. Money Center Banks provide small regional banks with banking facilities and services the smaller banks do not have.

A “non-recourse loan” is a loan that is strictly secured by an asset used to collateralize the loan. In case of default of the borrower, the lender has no recourse to the assets of the borrower save the seizure and forfaiture of the pledged asset.

The term “novation” applies to an agreement to: (1) replace one party to a contract with a new party. The novation transfers both rights and duties and requires the consent of both the original and the new party and (2) the replacement of an older debt or obligation with a newer one.”

An “option to call” or “call option” is a contract that grants the buyer of an option the right (but not the obligation) to purchase currencies, financial futures, or securities at a stated price, called the “exercise price.” In this invention, a Call Option is a contract between the “grantor” and the “grantee” in which the grantor grants an option to the grantee to call (right to purchase) from the grantor the investment or loan portfolio of the grantor at the exercise price prior to the expiration date of the option. In a Call Option, the right to exercise the option belongs to the grantee, and the grantee is obligated to perform if the grantee chooses to call.

An “option to put” or “put option” is the opposite of a Call Option where the rights and obligations of the parties are reversed. A Put Option obligates the seller of an option to buy a portfolio of loans or securities if the purchaser chooses to exercise his “right to sell” under the option.

The “option strike price” is the exercise price of the Call or the Put Option. In the case of a Call Option, it is the purchase price and in the case of a Put Option, it is the selling price.

The “participants” or “transaction participants” refer to the individuals or legal entities that become successful bidders on the exchange and whose bids are select for one or more transaction closings.

A “participation agreement” means any duly executed and delivered Participation Agreement between a Settlor and a Participant to establish the basis of that Person or Entity's relationship to a Participation Trust. It establishes the method of making deposits, withdrawals, and payments, as well as establishing the basis upon which the Person or Entity's beneficial interest in the Available Funds will be booked, profits and dividends accounted for, posted to the Person's account and reported on monthly statements of account.

A “participation trust” means a statutory trust that allows contributions to be made to the trust by third parties who, by virtue of their contributions, automatically become beneficiaries of a portion of the trust corpus to the extent of their note holdings or trust receipts relative to the total trust assets.

A “pledge/security agreement” is an agreement in which a borrower pledges an asset, as collateral, as a security interest to a lender for a loan. The Pledge/Security Agreement grants the lender a security interest in the pledged asset of the borrower until the loan is repaid.

The term “present value” is a formula that is widely used in discounted cash flow analysis. It calculates today's value of a payment or stream of payment amounts due and payable at some future date, discounted by a compound interest rate or discount rate. In other words, it is the total amount that a series of future payments is worth today. To calculate the Present Value of an investment or a series of cash flows the formula PV(rate,nper,pmt,fv,type) [e.g. as used in a Microsoft Excel™ spreadsheet] will return the present value of an investment, in which:

Rate is the interest rate per period.

Nper is the total number of payment periods in an annuity.

Pmt is the payment made each period and cannot change over the life of the annuity. If pmt is omitted, the fv argument must be included.

Fv is the future value, or a cash balance you want to attain after the last payment is made. If fv is omitted, it is assumed to be 0 (the future value of a loan, for example, is 0). If fv is omitted, the pmt argument must be included.

Type is the number 0 (end of period) or 1 (beginning of period) and indicates when payments are due.

A “refinancing” is the process of creating cash liquidity by selling, discounting or pledging an investment or an illiquid asset obtained as collateral for a loan. Frequently a bank will make a loan secured by certain collateral, then turns around and “refinances” itself, by converting the paper collateral into cash that can be relent by pledging in turn, the initial borrower's collateral, to the Central Bank under the “Borrower in Custody” program or to another bank in the inter-bank loan market. Diagram 1 attached hereto describes the process of how banks refinance themselves through a discounting process.

“registrar” means an institution duly appointed to perform all accounting functions for the Trust and to report monthly the account activity for each Participant.

A “repurchase agreement” or “repo agreement” between a seller and a buyer is an agreement whereby the seller agrees to repurchase the securities at an agreed upon price and, usually, at a stated time.

A “settlor” (also known as the Creator or Grantor) is the person or entity that enters into an agreement with a Trustee to form a new Trust.

A “sinking fund” means a pre-set amount set aside in a separate custodial account, at one time or at regular intervals, and that is used to redeem debt securities or service a debt. When used in this application, the term “sinking fund” applies to a one-time payment which is deposited in a custodial account and is invested over time so that the principal and investment returns will be sufficient to meet all future interest payment obligations of the borrower, when due. The sinking fund deposit is deducted from the loan proceeds at disbursement time and represents the present value of the future cash flow required to make interest payment.

The term “synthetic asset” refers not to an asset or portfolio of assets that are acquired but to an asset whose value is linked to other assets, such as securities, in combination. Hence, the asset is said to be synthetically acquired, and therefore, is said to be a synthetic asset in that the value is artificially created. For example, the simultaneous purchase of a Call Option and sale of a Put Option on the same security or investment portfolio creates a synthetic asset having the same value in terms of capital gain potential as the underlying security itself.

A “transaction unit” (or “TU”, if singular, and “TUs” if plural) is a notional indexed unit of measurement that governs all transactions on the exchange. For instance, instead of issuing a dollar-denominated or Euro-denominated note, all notes on the exchange are issuable in TUs only (or whatever other trademarked name is subsequently given this unit of measurement). Similarly all loans and refinancing strategies are done in TUs to allow worldwide bidders to trade on the exchange based on a standard unit of measurement that is known and accepted by all participants. This process of standardizing all world currencies into an indexed unit of barter is explained further in Diagram 12 and Diagram 2. A TU in a sense operates like a casino chip. It allows participants to convert local currencies into chips they play with, and reconvert into local currencies at the end of a session at the casino. When a new applicant opens a trading account on the exchange, he/she is required to open a trust account in a designated trust institution in his home country and to instantly and dynamically convert local currency holdings into TUs (at the then current index rate). This is done through a process that requires the account holder to purchase TUs from the exchange for deposit as start-up capital in his new trust account. Trading profits are accumulated in TUs. TUs may be redeemed for cash, and when redeemed, it is only payable in the local currency based on pre-agreed procedures, terms, conditions and minimum account balance requirements at the then current TU index rate. For the purpose of describing this Technology, when reference is made to TUs, it applies, in this illustration, to a baseline unit of gold as illustrated and discussed in Diagram 12.

In a sense a TU can be any unit of measurement that is priced daily, is published regularly, is accessible worldwide, and derives its value from an underlying asset, commodity or product. It can be for instance, an ounce of gold or any other metal, the price of a particular stock used to calculate a baseline unit, the price of a known commodity (e.g. the price of a bushel of wheat), or a known or created item (e.g. a widget). There is no limit as to the number of applications or promotional possibilities that the TU “indexing-for-trade” concept can have for any commodity, asset class, products (tangible or intangible—e.g. CO₂ credits, intellectual property units, etc.). For instance, if a TU is defined for a particular promotion as a widget, a ten-year zero coupon note having a face amount of 1,000 TUs corresponds to a purchase of 1,000 widgets at a discount (based on the yield to maturity desired). It carries with it a commitment to return 1,000 widgets at maturity of the note and works much like a future delivery contract. Thus instead of calling the instrument a note, it can be called a contract to deliver widgets at the maturity date. Debts can be settled in whole or in fractional widgets. Similarly, a ten year loan made in widget-equivalent TUs that carries an interest rate of say 4% per annum, is equivalent to the lender loaning 1,000 widgets through the exchange and receiving back 40 widgets per annum over a 10 year period and 1,000 widgets at the end of ten years.

A “trust” is an organization, usually combined with or within a commercial bank, which is engaged as a trustee, fiduciary or agent (with no conflict of interest) by a grantor individual or legal entity in the administration of trust funds or assets. A trustee holds title to property under the trust agreement for the benefit of another person or entity called the “beneficiary/ies”. A trust in law means a legally-created fiduciary relationship in which a qualified person or legal entity (one free of conflict of interest) called a “Trustee” holds title to property for the benefit of one or more Persons, called a “Beneficiary” or “Beneficiaries”. The agreement that establishes the Trust, contains its provisions, and sets forth the powers of the Trustee is called the Trust Agreement or the Trust Indenture. The person or entity creating the Trust is the Creator, Settlor, Grantor or Donor; the property itself is called the “corpus”, the “Trust Funds” or the “Trust Estate” which is distinguished from any income earned by it.

A “trust account” means a bank account or Trust account of a Master Trust or a Sub-Trust.

A “trust-issued receipt” is a Trust receipt issued by the Trustee of the Trust in favor of a Beneficiary to evidence the Beneficiary's pro-rata beneficial ownership in the Trust corpus up to the amount shown on the receipt. A Trust-Issued receipt operates much like a stock certificate of a corporation with the main difference being that in the case of a Trust, the assets of the Trust are managed by an independent Trustee in accordance with the pre-defined terms and conditions of the agreement governing the Trust.

A “trust-participation receipt” is a receipt issued by the Trust in favor of a Participant, that operates much like the Trust-Issued Receipt, except that it is issued in favor of a non-related third-party that causes deposits to be made to a Sub-account opened in the Participant's name under the master account of the Trust in accordance with the terms and conditions of a “Trust Participation Agreement,” thereby causing the Participant to be de-facto a Beneficiary of the Trust to the extent of the Participant's holdings in the Trust.

A “trust-linked debit card” is a term used to describe a debit card product which is the subject of U.S. Provisional Patent Application Ser. No. 60/630,233, filed Nov. 22, 2004.

The term “trust estate” means all rights, title and interests the Trust has in the aggregate of all cash deposits of Beneficiaries to their Trust Sub-Accounts at any point in time calculated as the total of all assets less the total of all liabilities, including set-aside reserves that are subject to a fiduciary duty of the Trustee. It is also the amount that is normally available for investment purposes, and it includes any and all accumulated and accrued interest, dividends or profits earned by the Trust as well as any other asset otherwise acquired by the Trust.

The term “trust funds” means the aggregate of all cash funds and other assets deposited to the credit of the Trust by the Settlor, Grantor, Beneficiaries or Participants.

A “trust indenture” is a legal agreement that establishes the Trust and appoints a Trustee to manage the assets of the Trust. It is an agreement entered into between a Settlor and a qualified Trustee which normally contain protective clauses for bond holders or Beneficiaries, including how funds are to be managed. Its provisions set forth the powers of the Trustee and establish the interest of the Beneficiaries or Participants in the assets held in Trust.

A “trust note” is a debt instrument that obligates the Trust to pay the holder of the note the principal and interest, if any, when due, in accordance with the terms of the Note. A Trust can create an indebtedness secured by Trust Assets, unless such activity is specifically prohibited by the Trust Agreement.

A “trustee” is a qualified (meaning free of a conflict of interest) person or legal entity, such as a Trust Company that holds title to property for the benefit of one or more Persons, called a “Beneficiary” or “Beneficiaries”. A Trustee is usually charged with investing Trust property productively for and on behalf of the Beneficiaries in accordance with the specific instructions of the Trust Agreement or Trust Indenture. The Trust Agreement will usually define whether the Trustee can make investment decisions of his own or whether he is only to execute investment orders submitted by a third-party asset manager.

The term “yield” as used herein is the return earned by a portfolio (loan or investment) expressed as an annual percentage of the original investment or loan amount. When used in respect of a particular security (e.g. a bond or a note) it normally refers to the yield to maturity (defined below).

The phrase “yield to maturity” or “YTM” applies to the formula that determines the rate of return an investor will receive if a long-term, interest-bearing investment, such as a bond or note, is held to the maturity date. It takes into account the purchase price, the redemption value, the time to maturity, the coupon yield, and the time between interest payments. Recognizing time value of money, it is the discount rate at which the present value of all future payments would equal the present price of the bond or note, also known as the IRR. It is implicitly assumed that coupons are reinvested at the YTM rate.

A “zero coupon security” or “zc note” or “zc bond” is a security that makes no periodic interest payments but instead is sold at a deep discount from its face value. The buyer of such a security receives the rate of return by gradual appreciation of the security, which is referred to as the face value on a specified maturity date. A zero coupon security can also be created by stripping the principal of a bond or note from its coupons and selling the stripped principal as a zero coupon instrument. The process of stripping the principal and the coupons of a security for sale separately to investors having different investment objectives is normally referred to as stripping. Stripping results in two separate and distinct instruments being created from a single interest-bearing note or bond. These two new securities are normally called “Interest-Only” (I/O) that has the features of an annuity product and “Principal Only (P/O) that has the features of a zero coupon instrument.

### DESCRIPTION OF THE TECHNOLOGY

The technology is a computer-implemented, multi- (or plural) tiered, efficient online electronic market-making system that incorporates its own built-in fiduciary, escrow, clearing and settlement mechanisms necessary to arbitrage loan interest rates and investment yield differences that exist in all countries of the world and to create a dynamic market where those desirous of borrowing and those desirous of investing can interact online to instantly close profitable transactions. The system facilitates the automatic sorting, analyzing and matching of bids received from worldwide bidders, the grouping of bids into country pairs, the calculations of financial returns and transaction details based on a set of parameters that are extrapolated from the accepted bids, the structuring of pre-set transactions designed to deliver an arbitrage profit to each participant in accordance with the accepted bid submitted, the closing of these transactions and the final clearing and settlement. The system includes amongst other things: (a) a dynamic online bid and ask system that allows worldwide participants to borrow or invest in their local currencies and to automatically refinance such transactions, through the global exchange, with a better yielding investment or a lower cost loan that automatically guarantees a profit to the successful bidder (the reverse is also possible where a transaction is first closed on the exchanged and is then followed by a local refinancing at rates that better yielding rates); (b) a method of submitting bids that are aggregated, sorted, analyzed, grouped by countries, and accepted or rejected on the basis of their desirability (measured in terms of the yield arbitrage opportunities it creates when measured against other bids) if the mathematics of the submitted bid permits an arbitrage profit to be achieved; (c) a system to capture worldwide bids expressed either in terms of a desired yield to maturity for an investment or an annual interest rate for a loan and to convert such bids into dynamic pricing needed to calculate the arbitrage opportunity it presents relative to other bids; ; (d) a system to match and group the most advantageous bids received into a series of up to 5 simultaneous closings that are designed to achieve the profit objectives of each successful bidder; (e) a system to mine the most profitable arbitrage opportunities from all the bids submitted through a system that first ranks these bids within countries and then matches the countries into country pairs that offer acceptable yield differentials; (e) a system that instantly and seamlessly accesses a repository database of pre-set legal forms that cover all aspects of any transaction done on the exchange and prepares al closing documentations electronically for a closing; (f) a system that converts each accepted bid into a set of financial data that apply to each transaction closing and automatically incorporates such data into the legal closing documentation that are then submitted third-party fiduciaries, custodians and trustees for an electronic closing on behalf of the successful bidders.

The Technology makes it possible for bids to be submitted in one of the five available market-making platforms on the exchange. This includes: (i) a first dynamic platform where a bidder can submit an offer to issue and sell secured notes at a desired yield to maturity, (ii) a second dynamic platform where a bidder can submit an offer to invest in or purchase secured and fully defeased notes issued by another successful bidder, (iii) a third dynamic platform where a bidder can submit an offer to make a loan secured by the notes of another successful bidder, (iv) a fourth dynamic platform where a bidder can submit an offer to borrow or refinance a portfolio of instruments issued by another successful bidder, (v) a fifth (a possible but not an essential part of the full transaction closing cycle) dynamic platform where a bidder can submit an offer to repurchase (repo) notes or loan portfolios that meet certain pre-defined conditions or achieve a desired objective, or to swap portfolios.

This database driven transactional application collects, sorts, analyzes, calculates, converts, stores and displays dynamic pricing information. The data is stored in a database of bids that changes rapidly within countries and internationally to reveal arbitrage opportunities. Rapid bid changes are encouraged and promoted through a process of directing the bidder at the onset to prepare and submit a bid that will have the highest probability of acceptance and is likely to result in a successful and profitable closing opportunity. This is achieved by giving an instant feedback online to the bidder that indicates the probability that his bid will be accepted as submitted. This analytical and probability forecasting mechanism is achieved by quickly analyzing the bid submitted relative to every other bid within that particular country and measuring this bid against other country pairs to see if there is a likelihood of a match at a minimum in each of the four bid platforms and returning the results of that assessment to the bidder. If the probability is low, the bidder will be encouraged to increase or decrease his yield or interest rate and to resubmit his bid in order to increase his chances of success. This process will have a tendency to move bidders toward a desirable yield or interest rate that will yield a positive arbitrage in either direction of a trade (issuance or repo). The analytical applications required to rapidly sort, analyze and select successful bids amongst potentially millions of such worldwide bids will be enhanced by another application designed to maximize the mining of each and every arbitrage opportunity that exist within a country or between selected pair countries. When a positive arbitrage is identified on one direction of a trade or another, the system will instantly lock-in the bids of the successful bidders, block their trust account deposits in TUs and proceed to issue the legal documentation and close the transaction through a seamless and simultaneous escrow closing process followed by a settlement to each successful bidder.

Referring to the description immediately above, as well as the details provided below in connection with reference to the drawings, the Technology and Invention may also be characterized as follows: a computer-implemented, plural-tiered, online electronic market-making system for plural participants, comprising: electronic market-making structure that allows the participants to issue, securitize, sell, trade, refinance, and repurchase plural financial products using a bid subsystem; and a bid subsystem that allows participants to create arid participate in worldwide interest-rate and yield-arbitrage opportunities created by the bids themselves and that are possible due to interest-related differences that exist between countries. The electronic market-making structure may include a two-tier subsystem of operation, with a first tier for the retail sector that is visible, and a second tier for the wholesale or institutional sector that is invisible but interfaces with the retail plane.

### DETAILED OF THE INVENTION

Turning now to details of the invention generally, the invention includes the creation of a fiduciary-driven global electronic exchange that facilitates the active online interaction of individuals, market-makers, financial institutions, or corporate entities and provides participants with a method to instantly submit bids, and close and settle interest rate and/or yield arbitrage transactions online. The system is designed to encourage and facilitate a rapidly changing and worldwide bid submission process that dynamically creates arbitrage opportunities (spread differentials) within countries or between country pairs so that the system can then engineer a successful and profitable online transaction closing between multi participants. This is done through a process of directing bidders at the onset to submit bids that will have the highest probability of acceptance in a transaction. This is achieved by giving an instant feedback online to the bidder regarding the probability that his bid will be accepted as submitted. This analytical and probability forecasting tool quickly analyzes each bid submitted relative to every other bid within a particular country or target country pairs, it measures the spread differential between bids to identify the likelihood of a match in each of the four bid platforms, and it returns the probability results to the bidder who can then adjust his bid accordingly. If the probability is low, the bidder is encouraged to increase or decrease his yield or interest rate bid and to resubmit to increase his chances of success.

When an arbitrage opportunity is identified, a series of closings are structured and executed as prescribed herein. Such closings, when they occur simultaneously in escrow, will either deliver a pre-defined level of profit for each participant or achieve a pre-known strategic benefit for the successful bidders. As is described below, the invention involves the issuance of custom-designed notes that are immediately sold online. This process is immediately and simultaneously accompanied by a simultaneous closing of a refinancing to liquefy the investment at a profit, a process known as discounting or forfaiting. The process of participation in such an exchange has been reduced to a simple level where the complexities of sophisticated financial transactions Will not be a barrier to entry for the less sophisticated financial brains of the world. Basically anybody who has access to a computer and the internet, and is able to borrow or invest locally in local currency will be able to participate on the exchange after he has opened a fiduciary account with the exchange and locally deposited funds in his account (a sub-account of a trust account of a participation trust which is locally managed by a trust company for the benefit of the customers of the exchange and the exchange itself).

Successful bidders are instantly able to issue, securitize (through a fiduciary relationship), sell, trade, refinance, or repurchase (repo) notes or loans, or create synthetic products (e.g. options to call and options to put financial products) through a dynamic online exchange that allows bids to be submitted by worldwide participants for either investments (e.g. the yield to maturity desired by an investor), secured loans (e.g. the interest rate desired by a lender) or the repurchase or reverse repurchase of instruments or loan portfolios. The system receives, sorts, indexes, groups and calculates all bids in order to automatically match the yields to maturity and the interest rate bids that create an arbitrage opportunity. When an arbitrage is identified the system looks for additional bids in the same country pair in order to confirm to at least four bidders that a closing can be done in escrow. The system automatically calculates the projected financial returns based on the accepted bid parameters and structures a pre-set series of transaction closing designed to deliver an arbitrage profit to each participant. When closed, the system clears and settles the transaction by generating a series of reports and legal documentation that are automatically transmitted to each closing participants.

Exchange participants make a profit in one of two ways. They can either: (a) borrow low and make a profit by placing borrowed funds in a higher yielding investment, or (b) they can invest high and discount the investment at a lower borrowing cost. Since money is created by the central banks of the world through the process of borrowing (investing does not give rise to money creation), borrowing or discounting is an essential part of the process incorporated in this invention. This is the same process which is described in Diagram 1 that banks all over the world use on a daily basis in their treasury operations. In the case of this illustration, banks receive funds from depositors and pay 3% interest on a time deposit [1]; they lend those funds at a 6% interest rate [2]; they then discount their investments yielding a 6% return at a lower refinancing rate of 3.25% [3] and [4]. Likewise the participants on the exchange can follow the same principle to make a profit in the same manner that banks do.

In the case of the parallel illustration, we show the exchange participants creating liquidity by, for instance, issuing and selling a note by offering to pay 4% to an investor [5] (the same thing banks do when they issue a certificate of deposit); reinvesting the proceeds at 5% either through a loan or through the purchase of a note on the exchange [6]; discounting the investment yielding a 5% return by borrowing at 4% [7] and [8]. As we have seen in this illustration, an investment is made, and the available cash balance is reduced, when a lender makes or loan or buys a note from a note issuer. Likewise a loan or a discounting process occurs, and the available cash balance is increased, when a note is sold (a form of borrowing) or when a secured loan is obtained.

Thus participants on the exchange can either:

(a) borrow or use existing cash assets in local currencies (deposited in the exchange's trust account to fund the account for trading purposes) to place these funds through the exchange at a rate that will yield a greater yield to maturity that they pay or can achieve locally. This applies mostly to countries where the interest rates are relatively low when compared with the prevailing rates of other countries. (b) issue and sell a note on the exchange that is then followed by a process of reinvesting locally at a higher yielding return on investment. This applies mostly to countries where the interest rates are relatively high when compared with the prevailing borrowing rates of other countries.

When the calculations done in the background to mine arbitrage opportunities identifies such a desirable spread opportunity, the system will automatically: (a) calculate the transaction parameters, (b) produce the mathematics that support multiple simultaneous closings (at least four), (c) accept the target bids by pre-advising the closing terms and conditions to each successful bidder who can then reconfirm, if they wish, their prior and final acceptance of the transaction parameters before a pre-set closing time, (d) convert successful bids into a locked-in transaction closing mode, (e) engineer each financial product and refinancing loan by incorporating in the calculations all the parameters of the successful bids, (f) create the legal documentation and paperwork which is automatically and instantaneously generated online (e.g. a non-recourse loan agreement) and financial products (e.g. a senior secured ten-year zero coupon note) needed to close a complete transaction, (g) close and settle all transactions via a simultaneous escrow closing process, (h) advise all participants of that a successful closing took place on the exchange for their benefit, (i) report and post all the details of the transaction to all concerned parties and to the trust accounts of successful bidders, () deliver, electronically, all financial instruments and legal documentation to the appropriate account coordinates of the respective parties (e.g. deliver the note to the account of the note buyer), (k) post confidential codes electronically to the account of each participant to enable them to access the details of the financial products they bought or sold or the loans they made or received, in such a way that they may exit their positions at any time, swap portfolios, resell, retire or reverse original investment or loan positions. The system is designed to simultaneously close and settle a pre-set type and number of transactions that guarantee each participant either a profit or at least the benefits desired by each of them (e.g. the accumulation of a secure high-grade portfolio of cash-backed higher-yielding notes that are held to maturity).

The Technology can potentially be used by financial institutions to accelerate the accumulation of a portfolio of high-grade secured loans, engage in treasury operations, create hedges for other transactions, develop currency and/or interest rate swap opportunities, engage in repo and reverse repo strategies, maximize tax advantages by shifting earnings to areas of the world that offer more attractive taxation structures, strengthen balance sheets at critical times, and legally create profits through transactions involving non-related parties and entities in the desired overseas offices by engaging in transactions on the exchange.

Individual participants, on the other hand, will play a critical role on the exchange as they may use the exchange to create profit opportunities or develop methods of financing projects in local countries. They have two options: If they reside in a country where interest rates are high (e.g. the Philippines, Mexico or South Africa), they will be able to invest in local currencies and refinance themselves on the exchange at a lower borrowing cost. In reverse, when interest rates of a country are comparatively low (e.g. Japan and Switzerland), they will be able to borrow locally and reinvest on the exchange at a better yield. The process of submitting bids on the exchange will have the following beneficial impact for the bidders and the economies of the world:
1. It will facilitate the reallocation of wealth (trading profits) to countries that need it the most for development purposes.
2. It will create a dynamic interest rate biding system that will hopefully bring equilibrium in the world's currency and interest rate markets by narrowing the disparity gap which currently exist between countries.
3. It will allow individuals worldwide to play a more active role, as market makers, in the establishment of interest rates and yields, which so far have rested almost exclusively in the hands of central bankers and banks who can, at will, raise or lower interest rates to impact an economy.
4. It will allow individuals worldwide to participate, for profit, in an electronic market that has heretofore exclusively been reserved for the more savvy traders, bankers in-the-know, and the wealth elite of the world, who have kept as closely guarded secrets the methods by which profits can be achieved from arbitrage operations, and are shielded by a complexity that is too great for a common man to understand.
5. It will reduce to a very simple and understandable level the process of participating, for profit, in what would be otherwise an impossible-to-understand trading process that involve the most complex and difficult-to-comprehend financial concepts and methodologies.

By borrowing in their local currencies and reinvesting the proceeds at a greater yield than that payable locally, they will play a critical role of establishing bid levels in a competitive market place.

Now turning to a description of the sequential process required to implement the Technology, the following descriptions are provided in supported of the flow charts and diagrams referred to herein:

Diagram 9, generally illustrates the account opening process for a person or an entity anywhere in the world who becomes an account holder and receives the authorization by the exchange or his/her market-maker node to submit bids and close transactions on the exchange. This process can also be directed through a local market-maker node that than feeds the information directly into the exchange's database.

Diagram 9, steps [5] through [10] describes the compliance approval process for each and every participant so as to ensure that such participants are and remain compliant with the laws or the originating country, and the host country as well as those of the exchange.

Diagram 9, steps [13] through [19] describes a process by which the adoption of standard pre-defined library of contracts will permit the exchange to dynamically and instantly create closing documentation for simultaneous online escrow closings. Such documentation will include but is not limited to, notes in various forms (e.g. with or without coupons), note purchase agreements, loan agreements, swap agreements, option agreements, refinancing agreements, master repo agreements, etc. The account opening and application registration process requires the applicant to check-off a series of anticipated activities of the applicant on the exchange. Based on the information provided the system will select a series of pre-defined standard forms of agreements and lead the applicant to: (a) review and adopt such forms of agreements as governing all transactions done on the exchange by the applicant or his designated agent (original adoption agreements will need to be mailed in original form), and (b) to allow the applicant to electronically download such forms for storage on the applicant's own computer.

Following the adoption of the above agreements by the new applicant, of all the forms that are likely to apply to the applicant's anticipated transactions, the account will be approved for trading whereupon the new account holder will be required to make a deposit (in his local currency) to a trust account (fiduciary) in his home country to secure 100% of his anticipated trading activities on the exchange (investments or loans). Such deposits may be arranged through a local market-maker, agent or institutional broker, based on pre-defined strategies the system will select and present for adoption all necessary legal forms to the new applicant.

Whereas the exchange may use the services of multiple market-makers and agents, the exchange will only use a single participation trust for each country and each trust shall be managed by a trustee resident in the target country. The trustee will arrange to open local trust accounts at regular banks, securities firms and institutions where such accounts will provide the flexibility of also being able to host multiple sub-accounts for each local trading participant on the exchange. When a new account is opened in the name of the new applicant, the local market-maker will be required to open a sub-account for the new account holder. When the new applicant makes a deposit to his account he will receive a trust certificate or a trust receipt to evidence his beneficial ownership of a portion of the trust estate. The trustee will only perform the duty of a fiduciary to guarantee the performance of the participant once a bid has been submitted and has been accepted. When a notice of bid acceptance is sent by the exchange to the local bidder, an electronic notification is simultaneously sent to the trustee who is required to immediately verify that the bidder's local account balance (in TUs) is sufficient to meet the bidder's contractual obligations triggered by the acceptance of the bid, and upon satisfactory confirmation of capacity, the trustee will block the account of the bidder for the amount of TUs needed to secure fully the counterparty risk created by the transaction (e.g. if a participant bids to issue and sell a ten-year 1,000 TU zero coupon note on the exchange and the price is 45.6387% of the face value [yield=8% per annum], the bidder's account will be blocked for 1,000 TU to guarantee repayment at maturity even though the price of the instrument is less) for as long as the obligation of the participant is engaged. When the instrument is resold, the system automatically release the block of 1,000 TUs on the account. In this respect, it is to be noted that all transactions done on the exchange will always be 100% backed by TUs at all times. This will create the confidence that when a note is bought and sold through the exchange the transaction is fully secured by deposits held in trust, for the amount of the participant's indebtedness. If an asset manager (Diagram 10 [3]) is able to invest locally available trust fund balances in pre-approved and safe investments that return a quantifiable pre-defined yield to the trust participants, it may be possible for the transaction to proceed with security deposit in trust only equal to the discounted present value of the 10 year note based on the achievable local rate.

Diagram 9, Steps [19] through [23] describes the process by which a new participant on the exchange will be required to convert his local currency deposit into TUs or TU-equivalents for trading purposes so that the trustee can guarantee performance (for a description of what a TU is please refer to the definition of terms section under “Transaction Unit”.

Diagram 9, Steps [24] through [27] describe a process through which a dynamic link can be created between the TU-denominated account and a Trust-linked Debit Card (which is the object of a separate patent application of this inventor) so that the TU account can be accessed and debited for debit transactions made on the card. In this case, each time a debit is made on the card at an ATM or at a merchant location, sufficient TUs are converted into local currencies in order to allow the debits to be immediately settled. This feature is the subject of a different but related U.S. Non-Provisional Patent application Ser. No. 60/630,233, filed Nov. 22, 2004 referenced above in the section “Cross Reference to Related Applications” section.

Diagram 12, (bottom half) describes the parameters the system needs to convert yield to maturity bids into a discount price of a note and to incorporate the coupon rate (the anticipate interest rate of the refinancing) in the calculations. To calculate the Discount rate of a note expressed as a percentage of the face value of a note, we use the following Excel spreadsheet formulas typically use for bond calculations:

=PRICE(Settlement,Maturity,Rate,Yield,Redemption,Frequency,Basis), where:

| | |
|---|---|
| Settlement | is the security's settlement date. The security settlement date is the date |
| | after the issue date when the security is traded to the buyer. |
| Maturity | is the security's maturity date. The maturity date is the date When the |
| | security expires. |
| Rate | is the security's annual coupon rate. |
| Yield | is the security's annual yield. << Bid percentages are applied here |
| Redemption | is the security's redemption value per 100 face value. |
| Frequency | is the number of coupon payments per year. For annual payments, |
| | frequency = 1; for semiannual, frequency = 2; for quarterly, frequency = 4. |
| Basis | is the type of day count basis to use. |

=YIELD(Settlement,Maturity,Price,Yield,Redemption,Frequency,Basis), where:

| | |
|---|---|
| Settlement | is the security's settlement date. The security settlement date is the date |
| | after the issue date when the security is traded to the buyer. |
| Maturity | is the security's maturity date. The maturity date is the date when the |
| | secunty expires. |
| Rate | is the security's annual coupon rate. |
| Price | is the security's price per 100 face value. |
| Redemption | is the security's redemption value per 100 face value. |
| Frequency | is the number of coupon payments per year. For annual payments, |
| | frequency = 1; for semiannual, frequency = 2; for quarterly, frequency = 4. |
| Basis | is the type of day count basis to use. |

The interest rate of the refinancing (the successful bid rate) automatically becomes the coupon rate of the note if a coupon note is desired. Otherwise, in the case of a zero coupon note, the percentage entered is 0% as the coupon value.

Diagram 11, describes the process used to receive electronic bid submissions from worldwide participants, sort & index in a database, prioritize in terms of the arbitrage opportunity it offers and match the bids for delivery to one of the four accepted “bid buckets” (or transaction-type platforms) so that an arbitrage transaction can instantly and seamlessly be engineered, calculated, pre-advised, legally documented and closed on the exchange.

Diagram 11, [1] or [12] illustrates the process used to: (a) submit and process a bid on the exchange expressed either as a “desired yield to maturity” on an investment or a “desired interest rate” for a loan or refinancing transaction, and (b) aggregate, sort and analyze all bids received.

Diagram 11, [13A], [14A], [13B], and [14B] represent the primary transactions available to participants on the exchange at the retail plane. In order for each of the four buckets to be activated and made ready for a transaction closing, there must be the following conditions present:
(a) [13A] must have a bid to issue and a bid to buy a note at the same yield. Alternatively the agreed yield could be the average between a bid and an ask.
(b) [14A] must have a bid to issue and a bid to buy a note at the same yield. Alternatively the agreed yield could be the average between a bid and an ask.
(c) [13B] must have a bid to make a loan and a bid to borrow at the same yield. Alternatively the agreed interest rate could be the average between a bid and an ask.
(d) [14B] must have a bid to make a loan and a bid to borrow at the same yield. Alternatively the agreed interest rate could be the average between a bid and an ask.

Even though the following is not essential, it is nevertheless preferable that the following conditions should exist to that the transaction, when closed can result in a benefit to all participants while positioning the transaction for a take-out at the wholesale level of the system:
(a) The same party (e.g. Party A) must be both a note issuer in [13A] and a lender in [14B],
(b) The same party (e.g. Party B) must be both a note issuer in [13B] and a lender in [14A],
(c) The same party (e.g. Investor 1) must be both a note buyer in [13A] and a borrower in [13B],
(d) The same party (e.g. Investor 2) must be both a note buyer in [14A] and a borrower in [14B],

Diagram 15, [15], Below the above four primary bid buckets Diagram 15 [13A], [14A], [13B], and [14B] that are visible on the retail plane, there are plural other invisible wholesale bid buckets (dynamic databases) maintained through market-maker nodes that allows financial institutions to submit confidential wholesale bids that are invisible on the retail plane. Such institutional bidding platform can be used by the institutions to submit bids to buy or sell local currencies, to buy or sell securities, to make or retire loans in TUs or in local currencies, to repurchase own financial products from third parties or to buy or swap loan or asset portfolios of transactions that shall have closed in escrow at the retail level. It can also be used to develop an options market, to swap currencies, interest rates, or to retire contracts or loans through an exit at the wholesale level of what is done at the retail level;

When a bid is transmitted and accepted by the retail system, it must satisfy the following requirements:
(a) It must state an interest rate expressed in yield to maturity or an annual interest rate desired. (e.g. 8% annualized yield to maturity on an investment)
(b) Since a full transaction cycle is not likely to last beyond a week, the interest or yield bid submitted should de divided by 52, representing the 52 weeks of the year. This means that if a full transaction cycle lasts 1 day instead of 7, the yield earned will have been seven times greater than anticipated. (e.g. 0.1538% for a one week cycle =8% .52).
(c) The bid must contain a fixed amount to be invested or loaned at the closing.
(d) The bid may contain certain restrictions (e.g. validity of the bid)
(e) The bid must applicable to TUs or later to NTUs.
(f) It must be backed by an amount deposited in trust at least equal to the bid amount in (c) above.
(g) It can be revolving or for one time only. If the revolving feature is used, it means that as soon as a full transaction cycle has been completed, the bid is automatically and immediately renewed and submitted to the system for an identical new bid for the same participant.
(h) It is preferable (but it is not an obligation) to submit a bid for a full transaction cycle in order to return the liquidity to the exchange. If the full transaction cycle feature is selected, the bid will be placed in both of the following buckets: either [13A] and [14A], or [13B] and [14B].

In order for a profitable arbitrage opportunity to exist and to become executable on the exchange, the following conditions must be present in each of the four platforms [13A], [14A], [13B], and [14B]: (a) the yield to maturity bids populating the “bid buckets” databases [13A] and [14A] must be the same or close to the same; (b) the loan interest rate bids populating the “bid buckets” databases [13B] and [14B] must be the same or close to the same; (c) the yield bid in buckets [13A] and [14A] must be greater than the interest rate found in “bid buckets” databases [13B] and [14B]. When such conditions exist, the transaction can close because a positive yield arbitrage exists and can be mined for the benefit of the transaction participants.

Diagram 11, Steps [15] through [18] describes the process of instantly calculating the parameters of the transaction and converting both an accepted bid to borrow (issuance and delivery of a promissory note) and an a bid to make a secured loan (issuance and delivery of a non-recourse loan agreement) into finished products that can be bought and sold on the exchange through a simultaneous escrow closing process where at least one bid is taken from each of the four bucket. To calculate the Discount rate of a note expressed as a percentage of the face value of a note, we use the following Excel spreadsheet formulas typically use for bond calculations:

=PRICE(Settlement,Maturity,Rate,Yield,Redemption,Frequency,Basis) where:

| | |
|---|---|
| Settlement | = is the security's settlement date. The security settlement date is the date |
| | after the issue date when the security is traded to the buyer. |
| Maturity | = is the security's maturity date. The maturity date is the date when the |
| | security expires. |
| Rate | = is the security's annual coupon rate. |
| Yield | = is the security's annual yield. <<<< Bid percentages are applied here |
| Redemption | = is the security's redemption value per 100 face value. |
| Frequency | = is the number of coupon payments per year. For annual payments, frequency |
| | =1; for semiannual, frequency =2 |
| Basis | = is the type of day count basis to use. |

Diagram 11, steps [19] through [21] describes the transaction cl sing process and the distribution and posting of arbitrage profits to the account of the successful bidders.

Diagram 13, steps [3] through [6] illustrates the method of matching and allocating the successful yield to maturity bids and interest rate bids into the four transaction buckets discussed above.

Diagram 13, steps [7] and [8] illustrate the conditions that are present for a successful closing of a full transaction cycle for each of the 4 participants in the illustration. The arbitrage transaction, when closed on the basis of what is illustrated here will result in a positive benefit to each of the participants. All closings are through a simultaneous and instantaneous escrow closing process executed electronically in seconds. When the four parties' transactions are closed simultaneously and the settlement has occurred a full transaction cycle is deemed completed and a new one can be reengineered if each of the 4 parties have agreed to the revolving feature of their bids.

Diagram 13, step [9] the settlement of profits mined from successful closings of arbitrage transactions is distributed immediately to the participants, such closings will result in a profit or a benefit that accrues to each successful bidder as illustrated herein.

Diagram 13, Steps [9] through [11] explains what happens for each set of separate (but related) closings and the inter-relationships of the parties (unrelated entities) to create mirrored transactions that can later be reversed (through a repo) or swapped at the appropriate time to suit an investor or a lender's specific objective. Once positioned for a repo, the transaction is primed to be seamlessly and effortlessly exited through the wholesale plane of the exchange.

Diagram 14, steps [12] and [13] describes the process of closing two simultaneous escrow transactions through the wholesale exit plane.

Diagram 14, steps [14] through [19] describes an optional and additional process of executing a third transaction closing that exits transactions closed at the retail plane to an institutional participant or market-maker operating at the wholesale plane. In the illustration we use Party C (a wholesale participant) who buys the entire portfolios (loans and notes) of Party A and B and swaps the notes of the parties in order to do a currency swap at a pre-set price. Steps [14] through [19] illustrate only one of the many exit strategies that can easily be implemented through the wholesale plane of the system.

Diagram 15, [15] illustrates how the wholesale plane of the exchange is immediately beneath the retail plane. It further explains the various activities that can be undertaken by institutions to support and facilitate the exchange while their activities remain invisible at the retail levels.

In addition to the descriptions provided above, the technology further consists of a method or system:

To create, among other things, a network of nodes and a low cost easy-to-use posting terminal for the virtual presentment of bids on the exchange expressed as a desired “Yield to Maturity” for an investment or as a desired “Interest Rate” for a loan (hereinafter referred to as the “bids”).

To establish a computer means to administrate, analyze and make a virtual presentment of bids on the exchange whether individually or in any other form of aggregation or categorization.

To provide a means of tracking, sorting, categorizing and prioritizing worldwide bids by originating country and the mapping and matching of country along pre-defined parameters to create multiple arbitrage opportunities.

To provide a means of merging multi-bids into a single transaction involving at least four separate closings, and which, together, provide an arbitrage opportunity for all participants To provide a means of merging and locking-in accepted bids to close one or more transactions through a simultaneous electronic escrow closing process.

To provide a means to calculate, estimate anticipated transactional arbitrage profits and to communicate a bid-acceptance notification directly to the successful bidder or via the market-maker node.

To provide a means to calculate and report transaction profits achieved through each successful transaction closing and to report same to the participant or to the submitting market maker node.

To establish a computer means to double tier a computerized market for interest rates and yield to maturity measured in TUs, where the first tier is a retail price and the second tier is a wholesale or institutional tier used solely by and for institutions.

To establish a computer means for market-makers to submit a second tier of bid (sub-bids) at wholesale rates that underlie the primary bids of participants and remains unseen to bidding participants, but that are used by the exchange to engineer immediate repos, swaps or option strategies designed to deliver the desired objectives of participants and market-makers. In this sense, market makers will be able to refinance or repurchase portfolios created and sold through the exchange at a rate that allows them to refinance themselves at a profit or to build an institutional portfolio of loans or instruments.

To establish a computer means for archiving records of bids and transactions in a computerized market-making bid system and distributing the archive to computer terminals that may then research and analyze bid trends, transactional accounting, reports and closing information.

To establish a dominant electronic “market-maker” node in each country of the world so that local trusts or financial institutions can become local market-makers for the exchange. All such nodes users or operators, hereinafter users, are “trusted” licensees or franchisers of the exchange and/or of the software and hardware necessary to create and submit bids to the exchange and operate a market-making node. The present invention will allow, or license, certain in-country market-making nodes to become a dominant market maker for a particular local or regional market, class of financial products, or investment strategy executable via the exchange. It should be noted that a market-making node user may sell virtual advertising space and may coordinate the sale of advertising space on a pool of market-making nodes to reach target market participants.

The market-maker node may have many modes of operation, including but not limited to: a software download mode, a bid mode, an analytical mode, a current bid tracking mode, a report generation mode, a fiduciary/custodial mode, a market-maker mode, a legal support mode, and an agent mode.

To provide an electronic agent interface node for institutional participants that allows such agents to search a plurality of market-making nodes to find matching bids within country pairs. The Agent Mode allows a market-making node participant to search a plurality of market-making nodes.

The present invention may allow a participant to electronically close a transaction with a market-maker node. By the interaction of a plurality of participants on a market-maker node or the posting of bids on the exchange via such nodes may establish a market or become a “market maker” for a particular country, product or currency.

Further, to provide a trusted network of fiduciary nodes that act as brokers, agents, trustees, custodians licensed to provide a means to electronically submit bid and represent third-party clients on the exchange.

To provide data analysis to the market-maker node users relative to the bids, pricing movements, and the total number and values of bids received in the virtual market.

To create a notional indexed unit of measurement that governs all transactions on the exchange. For the purpose of this description, this unit of measurement is referred to as a “Transaction Unit” and this process and the applications thereof relative to this patent is are further defined in the term definition section herein. A TU in a sense operates like a casino chip. It allows participants to convert local currencies into chips they play with, and reconvert into local currencies at the end of a session at the casino. Trading profits are payable in TUs. TUs may be redeemed for local currencies.

To create a process by which plural NEW TU units of trade (hereafter referred to as “NTUs”) may be created, indexed, measured, linked, traded, reported, and published so that trading on the exchange can take place by submitting yield and interest rate bids in NTUs instead of TUs. For instance, to illustrate an extreme application of how this process can work, assume that an NTU1 is linked to a case of 12×20 oz jars of mayonnaise of a particular brand which is deliverable F.O.B. the port of Seattle, Wash. (UPC code: XYZ) and the manufacturer of this product becomes a market maker for his own product by applying for a market-maker node specialized for the NTUs it desires to promote. In this case, if the manufacturer issues and sells a 1,000 NTU1 ten-year 5% coupon note, the act of issuing such a note will be equivalent to the manufacturer entering into a contractual obligation to deliver at maturity (like in a futures contract), in ten years, at the port of Seattle, on an FOB basis, a total of 1,000 cases of jars of mayonnaise plus a total of 50 cases every year over ten years. Thus instead of calling the instrument a financial note, it can be called a contract to deliver cases of mayonnaise. Note that such NTU1 obligations can be settled in whole or in fractional NTU1s. Similarly, a ten year loan made in NTU1 that carries an interest rate of say 4% per annum is equivalent to the lender loaning 1,000 cases of mayonnaise through the exchange and receiving back 40 cases per annum over a 10 year period and 1,000 cases at the end of ten years. Trading in NTU1 can be effected in exactly the same manner as explained herein for TUs with the difference that profits can be taken in NTU1 or in regular TUs since all NTUs will be automatically linked and indexed on a TU unit value.

To simulate the excitement and dynamic interaction found on a “live” exchange (e.g. a stock exchange) for the benefit of remote participants in the electronic bidding and transaction-engineering system.

### Computerized Implementation

In the preferred embodiment of the present invention a market-making node may use a multitasking operating system such as UNIX, OS/2, NT or VMS. However, a Microsoft DOS or Windows implementation is within the scope of the present invention. The market-making node may be networked via TCP/IP and the internet or a private TCP/IP network or X.25 private or public network or service providers network of ISDN, ATM and the like. It is understood, that a market-making node may support a plurality of protocols simultaneously. Moreover, it is understood that the participant interface application program may execute on a wide variety of platforms such as PC's, MACs, Power PC's, workstations, cable set-top boxes, and the like and are within the scope of the present invention.

### EXAMPLE N° 1

### (3.5 Full Transaction Cycles) The Issuance or Sr. Secured Note with Coupons

### Please Refer to Diagram 5

Diagram 5 is a diagram that illustrates the returns and benefits achieved by each transaction participants in a series of transaction closings that are repetitive in nature and involve: (a) a 1,000,000 TUs, ten (10) year note paying 4% coupons semi-annually and priced with a yield to maturity of 8% p.a., (72.8193% of face value or 728,193 TUs), and (b) a 4% interest rate and a 96% loan to value. These sets of numbers are applied in a repetitive fashion and assume that each of the 4 parties have given their consent to the revolving feature of their bids when submitted. This illustration further assumes the following strategic objectives and considerations:
(a) Party A and B are banks or financial institutions that can refinance themselves through the interbank market (LIBOR or EURIBOR) or through discount available through their central banks. They can intervene on the retail place of the system knowing that they also have access to the wholesale side of the system. Their primary objective in this case is to increase deposits that they can re-lend with a multiplier of 10:1. By being primarily on the lending side they have access to the multiplier effect as described in the background section hereabove.
(b) Investor 1 and Investor 2 are retail-level investors who have projects to fund and desire to profit from arbitrage transactions so that projects can be funded without resorting to bank loans. They do not desire to hold instruments to maturity. All their borrowings must be on a fully secured, fully defeased (interest and principal) basis and be on a non-recourse basis.

Diagram 5: Activity Blocks 1 and 2 Describe the Following Processes:
[5] Investor #1 deposits 1,000,000 Transaction Units (TUs) in his trust trading account in his country. He borrows 1,000,000 TUs from Party B and pledges his TUs on deposit as collateral. Important: It is not necessary to perform this transaction within the transaction cycle described herein. This borrowing can occur locally in the country of origin and can occur independently of the exchange.
[6] Investor #1 prepays the interest on the Loan by deducting 211,607 TUs from the loan proceed (the cumulative total of all Present Values of all annual interest payments due on the loan based on a loan interest of 4% p.a. and a similar yield of 4% on the deposit).
[7] Investor #1 receives net loan proceeds of 728,193 TUs and transfers it to his account.
[8] Investor #1 then takes the proceeds obtained from the Loan of Party B and uses 728,193 TUs of it to acquire a 1,000,000 TU, ten (10) year senior secured note issued by Party A.
[9] and [10] Investor #1, pledges this 1,000,000 TU Note in favor of Party B in exchange for a secured non-recourse loan of 960,000 TUs at an interest rate of 4% p.a. payable semi-annually in arrears. The loan is secured by the note principal due at maturity while the semi-annual interest payments are secured by the 4% coupons attached to the note).
[11] Investor #1 once again deposits the refinancing proceeds of 960,000 TUs in his trust account and buys another 10 year senior 4% coupon note issued by Party A at a cost of 728,193 TUs.
Etc. The cycle of buying and refinancing between Investor #1 and Parties A & B continues until such time as the bids of one of the parties is satisfied or one of the parties ceases to close additional transactions.

Diagram 5 illustrates how a mirror process is duplicated in reverse by Investor # 2 in Activity Blocks 3 & 4. In this case Investor #2 buys the notes of Party A and refinances with Party A, the reverse of what Investor #1 did. This process is essential in order to position all the transactions for a swap or repo at the wholesale plane of the exchange and so that it can produce a profit or a benefit for all concerned.

Summary Statements for Investor N^{o} 1 & Investor N^{o} 2
(Project Promoters)
(After 3.5 Full Transaction Cycles)
(Please refer to Diagram 7 attached hereto, sections [1] and [3])

| Borrowed 2,000,000 in local currency at x% interest | |
|---|---|
| per annum | |
| Submitted a bid on the exchange priced at x% (carrying | |
| cost) + y% (desired margin) y% in this case returned | |
| 483,313 TUs. (profit convertible in local currencies) | |
| Starting Trust Account Balance | 1,000,000 |
| Ending Trust Account Balance | 1,483,313 |
| Assets (in TUs): | |
| Starting Balance in Trust Account | 2,000,000 |
| Arbitrage Profits | 483,313 |
| Liabilities (in TUs) | |
| Non-Recourse, Secured Loans Payable | (**)4,000,000 |

(**)Loans are fully defeased and Secured by Notes

Summary Statement for Party A (Small Retail Bank)
(After 3.5 Full Transaction Cycles)
(Please refer to Diagram 7 attached hereto, section [2])

| | |
|---|---|
| Starting Trust Account Balance (Available on the Exchange) | 4,000,000 |
| Ending Trust Account Balance (Available to Trade) | 3,304,580 |
| Trust Deposit of Investors N^{o} 2 (Security on loans) | 1,000,000 |
| Assets (in TUs): | |
| Sinking Funds (Held in Trust) | 211,608 |
| Fully Defeased, Non-Recourse Loans Receivable | 4,000,000 |
| Liabilities (in TUs) | |
| Notes Payable (held by Party B as security) | 4,000,000 |

Summary Statements for Party B (Small Retail Bank)
(After 3.5 Full Transaction Cycles)
(Please refer to Diagram 7 attached hereto, sections [4])

| | |
|---|---|
| Starting Trust Account Balance (Available on the Exchange) | 4,000,000 |
| Ending Trust Account Balance (Available to Trade) | 3,304,580 |
| Trust Deposit of Investors N^{o} 1 (Security on loans) | 1,000,000 |
| Assets (in TUs): | |
| Sinking Funds (Held in Trust) | 211,608 |
| Fully Defeased, Non-Recourse Loans Receivable | 4,000,000 |
| Liabilities (in TUs) | |
| Notes Payable (held by Party A as security) | 4,000,000 |

### EXAMPLE N° 2

### (3.5 Full Transaction Cycles) The Issuance of Zero Coupon Notes Combined Sinking Funds to Fully Defease Loan Commitments

### Please Refer to Diagram 6

Diagram 6 illustrates a similar scenario as Example 1 above, except that this time a combination of zero coupon notes and a sinking fund are used to fully defease the principal and interest of the loans by securing the loan with a combination of the zero coupon note to guarantee the repayment of the principal at maturity and the sinking fund to guarantee the interest payments. The assumptions are: (a) a 1,000,000 TUs, ten (10) year zero coupon note priced with a yield to maturity of 8% p.a., priced at 45.6387% of face value or 456,387 TUs, and (b) a refinancing cost of 4% interest and a 96% loan to value with a sinking fund calculated based on the present values of 10 equal annual interest payment. The results in this case are as follow:

Summary Statements for Investor N^{o} 1 & Investor N^{o} 2
(Project Promoters)
(After 3.5 Full Transaction Cycles)
(Please refer to Diagrams 7 attached hereto, sections [1] and [3])

| Borrowed 2,000,000 in local currency at x% interest | |
|---|---|
| per annum | |
| Submitted a bid on the exchange priced at x% (carrying | |
| cost) + y% (desired margin) y% in this case returned | |
| 804,510 TUs.(profit convertible in local currencies) | |
| Starting Trust Account Balance | 1,000,000 |
| Ending Trust Account Balance | 1,804,510 |
| Assets (in TUs): | |
| Starting Balance in Trust Account | 2,000,000 |
| Arbitrage Profits | 804,510 |
| Liabilities (in TUs) | |
| Non-Recourse, Secured Loans Payable | (**)4,000,000 |

(**)Loans are fully defeased and Secured by Notes

Summary Statement for Party A (Small Retail Bank)
(After 3.5 Full Transaction Cycles)
(Please refer to Diagrams 7 attached hereto, section [2])

| | |
|---|---|
| Starting Trust Account Balance (Available on the Exchange) | 4,000,000 |
| Ending Trust Account Balance (Available to Trade) | 2,489,161 |
| Trust Deposit of Investors N^{o} 2 (Security on loans) | 1,000,000 |
| Assets (in TUs): | |
| Sinking Funds (Held in Trust) | 953,690 |
| Fully Defeased, Non-Recourse Loans Receivable | 4,000,000 |
| Liabilities (in TUs) | |
| Notes Payable (held by Party B as security) | 4,000,000 |

Summary Statements for Party B (Small Retail Bank)
(After 3.5 Full Transaction Cycles)
(Please refer to Diagrams 7 attached hereto, sections [4])

| | |
|---|---|
| Starting Trust Account Balance (Available on the Exchange) | 4,000,000 |
| Ending Trust Account Balance (Available to Trade) | 2,489,161 |
| Trust Deposit of Investors N^{o} 2 (Security on loans) | |
| Assets (in TUs): | |
| Sinking Funds (Held in Trust) | 953,690 |
| Fully Defeased, Non-Recourse Loans Receivable | 4,000,000 |
| Liabilities (in TUs) | |
| Notes Payable (held by Party A as security) | 4,000,000 |

### Preferred Embodiment

Turning now to an alternate way of characterizing the invention, the following numbered paragraphs are provided with the above description.
1. A computer-implemented multi-tiered online electronic market-making system and method (the “Exchange”), that allows participants to issue, securitize, sell, trade, refinance, repurchase (repo) plural financial products or loans through a bid process that allows global participants to create and participate in worldwide interest rate and yield arbitrage opportunities created by the bids themselves and that are possible due to the differences that invariably exist between countries (the “Technology”);
2. A system in accordance with paragraph 1 wherein the Exchange has a two-tier system of operation, one for the retail sector that is visible, the other for the wholesale or institutional sector that is invisible but interfaces with the retail plane;
3. A system in accordance with paragraph 1 wherein the Exchange can license or franchise wholesale market-maker nodes that operate seamlessly in the background and is supported by financial institutions who use such nodes to submit confidential wholesale bids that are invisible on the retail plane;

4. A system in accordance with paragraph 1 wherein worldwide bids can be submitted based on a simple and common standard that use the yield to maturity of an investment or the annual interest rate of a loan as the standard method of communicating a bidder's financial returns objective;
5. A system in accordance with paragraph 1 wherein bids and instantly and seamlessly converted into dynamic pricing needed to calculate the arbitrage opportunities a particular bid represents relative to every other bid;
6. A system in accordance with paragraph 1 wherein a bidder can submit an offer to invest in or purchase financial issued by another bidder at that bidder's bid level;
7. A system in accordance with paragraph 1 wherein a bidder can submit an offer to make a loan secured by the notes of another bidder at that bidder's bid level;
8. A system in accordance with paragraph 1 wherein a bidder can submit an offer to borrow or refinance a portfolio of instruments issued by another successful bidder;
9. A system in accordance with paragraph 1 wherein a bidder can submit a automatic revolving bid which renews and is posted again on the exchange after each successful transaction arbitrage closings;
10. A system in accordance with paragraph 1 wherein bids are collected, aggregated, sorted, analyzed, calculated, grouped by countries, ranked in order or their potential contribution, stored in a dynamic pricing information database and accepted or rejected on the basis of their desirability as measured in terms of the yield arbitrage opportunities they create when measured against other bids;
11. A system in accordance with paragraph 1 wherein bids are analyzed and ranked by country pairs in descending order of priority and desirability and where countries are then ranked in order of importance relative to the arbitrage opportunities made possibly by the bids received;
12. A system in accordance with paragraph 1 wherein rapid bid changes are encouraged and promoted through a process of directing the bidder at the onset to prepare and submit a bid that will have the highest probability of acceptance. This is achieved by giving an instant feedback online to the bidder to indicate the probability that his bid will be accepted or rejected.
13. A system in accordance with paragraph 12 wherein this analytical and probability forecasting mechanism is achieved by analyzing the bid submitted relative to every other bid within that particular country and measuring this bid against other countries to see if there is a likelihood of a match at a minimum in each of the four bid platforms and returning the results of that assessment to the bidder.
14. A system in accordance with paragraph 2 wherein the mathematics pertaining the submitted bids permits the immediate calculations of the profits that can be generated by a particular arbitrage opportunity;
15. A system in accordance with paragraph 1 wherein the bidding process promotes the cooperative mining of interest rate and yield differentials that exist within a single currency or between different currencies for the purpose of maximizing the arbitrage differential and profits for the arbitragers;
16. A system in accordance with paragraph 1 wherein financial products are instantly created, loans issued and a refinancing engineered so as to create a transaction closing online that deliver a profit or a pre-defined benefit to each participant;
17. A system in accordance with paragraph 1 wherein a dynamic exchange is created to allow worldwide participants to bid to borrow or invest in their local currencies and to automatically refinance such transactions, through the global exchange, with a better yielding investment or a lower cost loan that automatically guarantees a profit to the successful bidder;
18. A system in accordance with paragraph 1 wherein a dynamic platform is created to allow a bidder to submit an online offer to repurchase (repo) or swap notes or loan portfolios that meet certain pre-defined conditions or achieve a desired objective;
19. A system in accordance with paragraph 1 wherein a global electronic disintermediation system is created to allow investors and lenders to come together within the context of a global electronic exchange in order to bid for a share of the profits that would normally accrue to financial institutions;
20. A system in accordance with paragraph 1 wherein the exchange incorporates a fiduciary, custodial, escrow, clearing and/or settlement mechanism or feature necessary to create a secure arm's length arbitrage opportunity that protects all parties interests;
21. A system in accordance with paragraph 1 wherein participants can interact online to instantly produce profitable arbitrage opportunities that can be closed quickly and efficiently by the parties through the use of the Technology;
22. A system in accordance with paragraph 1 wherein the system mines the most profitable arbitrage spread opportunities first from all the bids submitted;
23. A system in accordance with paragraph 1 wherein the most advantageous bids that create the greatest arbitrage spread are accepted and automatically locked-in and grouped with at least three other bids to create a series of four pre-defined and specified transaction closings that will occur simultaneously in escrow and will yield a profit or a benefit for the participants when closed;
24. A system in accordance with paragraph 1 wherein the system accepts and locks-in five separate successful “bids” and “asks” that are then grouped into three simultaneous closing batches: (1) the average of the bid and ask yield for the issuance and sale of a financial product; (2) the average of the bid and ask interest rate for a fully defeased refinancing loan secured by either cash or cash-backed financial instruments; (3) the lowest refinancing interest rate bid offered by a repo/swap counterparty operating at the wholesale level of the exchange (lowest interest rate available for the term of the note);
25. A system in accordance with paragraph 1 wherein a system matches country pairs and groups the most advantageous bids received within those pairs into a series of up to four simultaneous closings to occur on the retail level and that are designed to achieve the profit objectives of each successful bidder;
26. A system in accordance with paragraph 1 wherein the wholesale platform can be used by institutions to develop an options market, to swap currencies, interest rates, or to retire contracts or loans through an exit at the wholesale level of what is consummated at the retail level.
27. A system in accordance with paragraph 1 wherein institutions can use the wholesale platform to submit underlying bids to buy or sell local currencies, to buy or sell securities, to make or retire loans in TUs or in local currencies, to repurchase their own financial products from third parties or to buy or swap loan or asset portfolios of transactions that have closed in escrow at the retail level;
28. A system in accordance with paragraph 1 wherein prior to closing, accepted transactions are seamlessly interfaced with an in-house repository database library of pre-set legal forms that cover all aspects of the contemplated transaction closings in order to select automatically and without human intervention the appropriate forms based on the type of transaction closings involved;
29. A system in accordance with paragraph 1 and 28 wherein done on the system automatically prepares, distributes and stores for retrieval all electronically closing documentation for transactions that close;
30. A system in accordance with paragraph 1 and 28 wherein all exchange participants are required to adopt the standard forms of legal documentations used by the exchange by simply executing a one time adoption agreement that causes them to adopt a complex and extensive standard set of pre-established supporting legal documents for a precisely defined set of transaction closings;
31. A system in accordance with paragraph 1, 28 and 29 wherein each accepted bid data is converted into a series of financial information that is automatically incorporated into the legal closing documentation;
32. A system in accordance with paragraph 1, 28 and 29 wherein final legal documentation is transmitted electronically to third-party fiduciaries, custodians and/or trustees for an electronic escrow closing online on behalf of the successful bidders;
33. A system in accordance with paragraph 1 and in accordance with the preset method of matching bidders into the four transaction buckets as described in Diagram 15, FIG. [13A], [13B], [14B] and [14A] wherein such transactions will deliver a profit or a desired advantage for the participants;
34. A system in accordance with paragraphs 33 and 1 wherein such groupings into the four buckets result in a mirrored transactions that leaves Party A and Party B holding reciprocal and identical assets and liabilities that they can later swap or exit directly or through the creation of credit-linked notes or derivatives;
35. A system in accordance with paragraph 33 wherein all four transactions can be closed simultaneously and electronically in escrow in order to eliminate risks.;
36. A system in accordance with paragraph 1 wherein a new currency of trade on the exchange is created (herein called a “transaction unit” or “TU”) which can be an indexed notional currency that derives its value from an underlying commodity, currency, or product;
37. A system in accordance with paragraphs 1 and 36 wherein bids can be submitted and closings done through the Exchange in any currency of the world, or in TUs, or NTUs as defined herein;
38. A system in accordance with paragraphs 1 and 36 wherein TU can be indexed on any baseline unit of measurement that is priced and published regularly, is accessible worldwide, and derives its value from any underlying asset (tangible or intangible—e.g. CO₂ credits, intellectual property units, etc.), commodity (e.g. an ounce of gold; silver platinum, a bushel of wheat) or product (e.g. a widget, a case of food product, etc.). In a sense, TUs operates much like a casino chip, currencies are converted at the onset and at the outset leaving the casino player with the benefit of being to use a standard and acceptable unit of measurement while in the casino;
39. A system in accordance with paragraphs 1 and 36 and 38 wherein the TU indexing for trade and settlement concepts of the Technology can be used to create new markets for products and ideas, to market and promote a wide range of products, create new and dynamic markets for products (e.g. food products or widgets);
40. A system in accordance with paragraphs 1 and 36 and 39 wherein the TU indexing for trade and/or settlement concepts of the Technology can be used to create new and dynamic markets for products, trade in a wide range of products or commodities, create new markets for products and ideas, (e.g. food products or widgets);
41. A system in accordance with paragraphs 1 and 36 wherein local currency holdings are freely convertible into TUs and vice versa;
42. A system in accordance with paragraph 1 and 2 wherein the Exchange clears and settles transaction by generating a series of reports and legal documentation that are automatically transmitted to each closing participants and by transferring TU profits to the trust account of the successful participant;
43. A system in accordance with paragraph 1 and 2 wherein account holder deposits are maintained in local currencies in local trust accounts and are converted into TU units immediately prior to a transaction closing. Similarly when the proceeds from a transaction closing settlement occurs, funds are deposited in TUs and can be freely exchanged back into the local currency;
44. A system in accordance with paragraph 1 wherein the exchange posts confidential codes electronically to the account of each participant to enable them to access the details of the financial products they bought or sold or the loans they made or received;
45. A system in accordance with paragraph 2 wherein successful bid parameters are used to create pre-defined financial products and refinancing that incorporate the parameters of successful bid yield and interest rate refinancing in order to create instant transaction opportunities;
46. A system in accordance with paragraph 3 wherein the financial products and loans and closing that that instantly issues a series of financial products, loan portfolios and fully defeased refinancing so as to produce a profit for all closing participants;
47. A system and method of arbitraging interest rates and investment yield differentials that exist between financial products and loans portfolios issued in various countries and the stripping those differences for the purpose of creating a pre-defined and quantifiable profit for investors as well as a substantial benefit to the institutions that participate in the process;
48. A system in accordance with paragraph 1 wherein a dynamic interest rate biding system will hopefully evolve from the Technology to bring equilibrium in the world's currency and interest rate markets by narrowing the disparity gaps which currently exist between countries;
49. A system in accordance with paragraph 1 wherein the Technology may be applied to any country pairs, in any currency and amount;
50. A system in accordance with paragraph 1 wherein a note can be replaced by one or more zero coupon notes, promissory notes, certificates of deposits, debentures that mature concurrently with the maturity date of any form of refinancing;
51. A system or method in accordance with paragraph 1 wherein a zero coupon note can be replaced by a sinking fund or any other form of trust deposit of cash or marketable securities that guarantees the future payment or repayment of principal and/or interests on a loan or discounting or forfaiting, wherein such trust assets are used to secure future obligations under the terms and conditions of a trust indenture or any other form of trust arrangement between grantor and trustee;
52. A system or method in accordance with paragraph 1 wherein a defeased loan is replaced by a straight exit sale of the underlying asset used to collateralize the loan and this is done through the execution and delivery of a “novation” agreement that transfers all rights, title and interest to the buyer and allows the seller to remove both the asset and liabilities related to the investment portfolio and/or any bridge refinancing from its books;
53. A system or method in accordance with paragraph 1 wherein a repurchase mechanism (“Repo”) is accomplished through an exchange of stock or other financial instruments of the issuer as full and final settlement for the Repo;
54. A system or method in accordance with paragraph 1 wherein financial products created by the exchange for a closing may have any maturity date, may be for any amount or currency;
55. A system or method in accordance with paragraph 1 wherein any refinancing mechanism involves a Repo (repurchase by the original issuer) or a reverse Repo (repurchase by the original issuer with an added requirement that the same instrument will be later reacquired by the same seller);
56. A system or method in accordance with paragraph 1 wherein the Technology is implemented with or without hedging of currency or any other investment risk whatsoever;
57. A system or method in accordance with paragraph 1 wherein the refinancing of the investment portfolio is done through reinsurance;
58. A system or method in accordance with paragraph 1 wherein the registration of the Financial Instruments may or may not include an original CUSIP or ISIN registration number (the “Registration Number”) to facilitate the settlement through one of the recognized fiduciary third-party settlement organizations whether such securities are issued in global form or not, and/or involve any form of securities swap/transfer implemented by a change of the Registration Number of the original securities. CUSIP (“Committee on Uniform Securities Identification Procedures”) is a nine digit securities numbering system used in the US and Canada. An International Securities Identification Number (ISIN) code consists of an alpha country code (ISO 3166) or XS for securities numbered by CEDEL or Euroclear, a 9-digit alphanumeric code based on the national securities code or the common CEDEL/Euroclear code, and a check digit;
59. system or method in accordance with paragraph 1 wherein a refinancing or Repo transaction is recognized on that party's balance sheet or alternatively is engineered as an off-balance-sheet financing or refinancing for the purpose of not adding debt on a balance sheet, whether or not such off-balance-sheet transaction involves the sale of receivables with recourse, take-or-pay contracts, bank financial instruments and whether such transaction involves or not a credit, market or liquidity risk;
60. A system or method in accordance with paragraph 1 wherein a synthetic arbitrage opportunity is created through a system of options, debt swap, forfaiting or discounting or the swap of future cash flow streams discounted to their present values;
61. A system or method in accordance with paragraph 1 wherein a sale or a repo involves the use of put and call options or not;
62. A system or method in accordance with paragraph 1 wherein swap arrangements are arranged directly between the two swap counterparty financial institutions or through the intermediation services of a third financial institution acting as a facilitator or any other third-party arranger or facilitator;
63. A system or method in accordance with paragraph 1, 15, 16, 17, 18, 24, 26 wherein medium and term financial instruments and loans can be quickly, swapped or repurchased to eliminate counterparty credit risks and retired by the original issuer without the original instruments having to held by an investor for the life of the product or loan.
64. A system or method in accordance with paragraph 1, 15, 16, 17, 18, 24, 26, and 63 wherein the arbitrage of interest rate and yield differential between two different curries can be implement without resorting to traditional currency hedges, swaps or futures contracts that usually strip most or all of the benefits out of an arbitrage.

The specific embodiments of the invention as disclosed and illustrated herein are not to be considered in a limiting sense as numerous variations are possible. The subject matter of this disclosure includes all novel and non-obvious combinations and sub-combinations of the various features, elements, methods, functions and/or properties disclosed herein. No single feature, function, element or property of the disclosed embodiments is essential. The following claims define certain combinations and sub-combinations which are regarded as novel and non-obvious. Other combinations and sub-combinations of features, functions, elements, methods and/or properties may be claimed through amendment of the present claims or presentation of new claims in this or a related application. Such claims, whether they are different, broader, narrower or equal in scope to the original claims, are also regarded as included within the subject matter of the disclosure.

I claim:

1. A computer-implemented, plural-tiered, online electronic market-making system for plural participants, comprising:
electronic market-making structure that allows the participants to issue, securitize, sell, trade, refinance, and repurchase plural financial products using a bid subsystem; and
a bid subsystem that allows participants to create and participate in worldwide interest-rate and yield-arbitrage opportunities created by the bids themselves and that are possible due to interest-related differences that exist between countries.

2. The system of claim 1, wherein the electronic market-making structure includes a two-tier subsystem of operation, with a first tier for the retail sector that is visible, and a second tier for the wholesale or institutional sector that is invisible but interfaces with the retail plane.
